(19) United States
(12) Patent Application Publication
(10) Pub. No.: US 2025/0284116 A1
(43) Pub. Date: Sep. 11, 2025

(54) HIGH DENSITY MEMS MICRO MIRROR MATRIX

(71) Applicant: Preciseley Microtechnlolgy corporation, Burnaby (CA)

(72) Inventors: Lawrence LAM, Burnaby (CA); Tiansheng ZHOU, Burnaby (CA); Qiuyang XIONG, Burnaby (CA); Kevin Earl KORNELSEN, Burnaby (CA)

(21) Appl. No.: 19/074,768

(22) Filed: Mar. 10, 2025

Related U.S. Application Data
(60) Provisional application No. 63/562,815, filed on Mar. 8, 2024.

(51) Int. Cl. G02B 26/08; G02B 26/10

(52) U.S. Cl. CPC G02B 26/0833; G02B 26/101

(57) ABSTRACT

A mirror array apparatus may include a mirror array including a first mirror and a second mirror; a drive array including a first drive configured to drive the first mirror and a second drive configured to drive the second mirror; and a trace layer including a first trace electrically coupled to the first drive and a second trace electrically coupled to the second drive. The mirror array may be disposed above the trace layer, and at least portion of the first trace may overlap the second mirror and passes below the second mirror.

### TECHNICAL FIELD

The present invention is directed towards the construction of high-density micro-mirror matrix useful for optical cross-connect (OXC) application.

### BACKGROUND

The MEMS (Micro-Electro-Mechanical Systems) micro-mirror has wide applications in fiber optic communication, where light signal attenuation, switching and even modulation can be achieved by steering the beam via micro-mirror. A two-dimensional mirror array is essential to construct the optical cross-connect for datacenter networking. The optical communication industry has been seeking solutions to build low cost, high port count, low switching time optical switches for optical cross-connections for a long time. To increase the number of channels in the cross-connect system, the number of mirrors on the MEMS mirror matrix needs to increase as well as maximum tilting angle of each mirror. As the size of array grows, the signal routing of such device becomes extremely challenging, particularly in applications where the MEMS mirror operates at high voltage. At the same time, systems designers are trying to reduce the system footprint and there is demand for smaller chips. As result, the silicon area left for MEMS actuators and traces for signal path are heavily limited. and causes a series of technical challenges, such as the decreasing drive force, drive interfering between channels, the limited tilting range etc., that cannot be easily resolved.

### SUMMARY

According to an aspect, a construction of high-density matrix of MEMS micro mirrors that can rotate in two degree of freedom and be addressed continuously and individually is disclosed.

In one embodiment, the pivoting mirrors with movable MEMS electrostatic comb drive may be formed on the first device layer. the stationary part of the electrostatics comb drive may be formed on the second device layer. A third device layer is sandwiched by two insulating layers and attached to the bottom of the second substrate layer. A trench re-fill technique may be utilized to establish electrical connection vertically between the stationary electrostatic comb drive that is situated inside the second device layer and the third device layer where the traces are formed with in. The third device layer is conductive and may be made of silicon or other materials. The high voltage compatible silicon trace is insulated by air and sealed hermetically with low pressure inert gas to enhance breakdown voltage threshold. The traces may be fan out to certain or all side of the chips to allow for chip-to-chip stitching to further scaling up the system channel count and at the same time reduce chip cost. An additional high optically transmissive layer may be attached via glass frit or low temperature bonding process to the top of first layer to protect the released MEMS structure and enable a wafer level packaging that provides hermeticity to enhance long term reliability to the MEMS device.

In one embodiment, a mirror array apparatus may include a mirror array including a first mirror and a second mirror; a drive array including a first drive configured to drive the first mirror and a second drive configured to drive the second mirror; and a trace layer including a first trace electrically coupled to the first drive and a second trace electrically coupled to the second drive. The mirror array is disposed above the trace layer, and at least portion of the first trace overlaps the second mirror and passes below the second mirror.

In one embodiment, the mirror array may include a first mirror group including the first mirror and the second mirror, and a second mirror group including a third mirror and a fourth mirror, the trace layer may further include a third trace associated with the third mirror and a fourth trace associated with the fourth mirror, and at least portion of the third trace may overlap the fourth mirror and passes below the fourth mirror.

In one embodiment, the mirror array apparatus may further include a first bonding array including a first bonding pad electrically coupled to the first trace and a second bonding pad electrically coupled to the second trace; and a second bonding array including a third bonding pad electrically coupled to the third trace and a fourth bonding pad electrically coupled to the fourth trace.

In one embodiment, the first bonding array may extend in a first direction perpendicular to a second direction in which the second bonding array extends.

In one embodiment, the first trace may include a first portion extending to the first bonding array in the second direction perpendicular to the first direction in which the first bonding array extends and a second portion extending to the first bonding array in a third direction different from the first direction and the second direction.

In one embodiment, the third trace may include a third portion extending to the second bonding array in the first direction perpendicular to the second direction in which the second bonding array extends and a second portion extending to the first bonding array in the third direction different from the first direction and the second direction.

In one embodiment, the first bonding array and the second bonding array may extend in a first direction.

In one embodiment, the first trace may extend to the first bonding array in a second direction perpendicular to the first direction, and the third trace may extend to the second bonding array in the second direction.

In one embodiment, the mirror array apparatus may further include a first via electrically connecting the first drive to the first trace; and a second via electrically connecting the second drive to the second trace.

In one embodiment, the trace layer may include a first trace layer including the first trace and a second trace layer including the second trace, and the first trace layer may be disposed above the second trace layer.

In one embodiment, a mirror array apparatus may include a plurality of first mirrors disposed in a first direction; a plurality of second mirrors disposed in a second direction perpendicular to the first direction; and a plurality of third mirrors disposed in a third direction different from the first direction and the second direction. A first trace associated with one mirror of the plurality of first mirrors may extend below other mirrors of the plurality of first mirrors in the first direction, a second trace associated with one mirror of the plurality of second mirrors may extend below other mirrors of the plurality of second mirrors in the second direction, and a third trace associated with one mirror of the plurality of third mirrors may extend below other mirrors of the plurality of third mirrors in the third direction.

In one embodiment, at least portion of the first trace may overlap the other mirrors of the plurality of first mirrors, at least portion of the second trace may overlap the other mirrors of the plurality of second mirrors, and at least portion of the third trace may overlap the other mirrors of the plurality of third mirrors.

In one embodiment, the first trace may be electrically connected to a first drive configured to drive the one mirror of the plurality of first mirrors, the second trace may be electrically connected to a second drive configured to drive the one mirror of the plurality of second mirrors, and the third trace may be electrically connected to a third drive configured to drive the one mirror of the plurality of third mirrors.

In one embodiment, the mirror array apparatus may further include a plurality of fourth mirrors disposed in a fourth direction different from the first direction, the second direction and the third direction. A fourth trace associated with one mirror of the plurality of fourth mirrors may extend below other mirrors of the plurality of fourth mirrors in the third direction.

In one embodiment, the fourth trace may be electrically connected to a fourth drive configured to drive the one mirror of the plurality of fourth mirrors, and at least portion of the fourth trace may overlap the other mirrors of the plurality of fourth mirrors.

In one embodiment, a mirror array apparatus may include a plurality of first mirrors; a plurality of first drives configured to drive the plurality of first mirrors, respectively; a plurality of first traces electrically connected to the plurality of first drives, respectively; a plurality of second mirrors; a plurality of second drives configured to drive the plurality of second mirrors, respectively; and a plurality of second traces electrically connected to the plurality of second drives, respectively. One first trace of the plurality of first traces may pass below the plurality of first mirrors and at lease portion of the one first trace overlaps with the plurality of first mirrors, and one second trace of the plurality of second traces may pass below the plurality of second mirrors and at lease portion of the one second trace overlaps with the plurality of second mirrors.

In one embodiment, the mirror array apparatus may further include a first bonding array including a plurality of first bonding pad electrically connected to the plurality of first traces, respectively; and a second bonding array including a plurality of second bonding pad electrically connected to the plurality of second traces, respectively.

In one embodiment, the plurality of first mirrors may be arranged in a row in a first direction, and the first bonding array may extend in a second direction perpendicular to the first direction. In one embodiment, the plurality of second mirrors may be arranged in a row in the second direction, and the second bonding array may extend in the first direction perpendicular to the second direction.

In one embodiment, the first bonding array may be disposed on one side of the plurality of first mirrors and the plurality of second mirrors, the second bonding array may be disposed on other side of the plurality of first mirrors and the plurality of second mirrors, the plurality of first mirrors and the plurality of second mirrors may be arranged in a row in a first direction, and the first bonding array and the second bonding array may extend in a second direction perpendicular to the first direction.

In one embodiment, a mirror array apparatus comprises a first mirror group including a plurality of first mirror lines; a second mirror group including a plurality of second mirror lines; a first bonding array including a plurality of first bonding pad electrically connected to the first mirror group; a second bonding array including a plurality of second bonding pad electrically connected to the second mirror group, wherein the first bonding array is disposed adjacent to one ends of the plurality of the first mirror lines and the second bonding array is disposed adjacent to one ends of the plurality of the second mirror lines, and wherein the first bonding array and the second bonding array form an L-shape.

In one embodiment, the first bonding array is disposed perpendicular to the second bonding array, and one end of the first bonding array is adjacent to one end of the second bonding array.

In one embodiment, each of the plurality of the first mirror lines includes a plurality of first mirrors, and each of the plurality of the second mirror lines includes a plurality of second mirrors.

In one embodiment, at least some of the first mirrors is arranged along a first direction, and at least some of the second mirrors is arranged along a second direction perpendicular to the first direction.

In one embodiment, the first bonding array is disposed so that its longitudinal direction is parallel to the second direction the second bonding array is disposed so that its longitudinal direction parallel to the first direction.

In one embodiment, at least one of the plurality of the first mirror lines is angled at a first angle, and at least one of the plurality of the second mirror lines is angled at a second angle.

In one embodiment, a mirror array module comprising a plurality of mirror array apparatuses comprises: a first mirror group including a plurality of first mirror lines; a second mirror group including a plurality of second mirror lines; a first bonding array including a plurality of first bonding pad electrically connected to the first mirror group; and a second bonding array including a plurality of second bonding pad electrically connected to the second mirror group, wherein the first bonding array is disposed adjacent to one ends of the plurality of the first mirror lines and the second bonding array is disposed adjacent to one ends of the plurality of the second mirror lines, and wherein the first bonding array and the second bonding array form an L-shape.

In one embodiment, the first bonding array and the second bonding array are disposed along edges of the mirror array module.

In one embodiment, the plurality of mirror array apparatuses have different placement angles.

In one embodiment, a method for manufacturing a mirror array module comprising a plurality of mirror array apparatuses comprises: disposing a first mirror array apparatus including first mirrors and first bonding pad arrays on a plane; and disposing a second mirror array apparatus including second mirrors and second bonding pad arrays on the plane, rotated by a predetermined angle with respect to the first mirror array apparatus so that the first bonding pad arrays and the second bonding pad arrays are located along edges of the mirror array module.

In one embodiment, a mirror array apparatus comprises a mirror matrix including a first mirror group and a second mirror group; a first bonding array including a plurality of first bonding pads associated with a plurality of first mirrors in the first mirror group; a second bonding array including a plurality of second bonding pads associated with a plurality of second mirrors in the second mirror group, wherein the first bonding array is disposed on one side of the mirror matrix, and the second bonding array is disposed on adjacent another side of the mirror matrix, wherein one end of the first bonding array is adjacent to one end of the second bonding array.

In one embodiment, the first bonding array is disposed perpendicular to the second bonding array, and wherein the first bonding array and the second bonding array form an L-shape.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1a is a perspective view of a MEMS mirror matrix structure.

FIG. 1b is a cross-sectional view of MEMS mirror matrix structure.

FIG. 2 is a cross-sectional view of the silicon routing layer sitting on substrate.

FIG. 3 is a plot breakdown voltage vs pressure and gap size extracted from the reference literature.

FIG. 4 is the top view of the traces and via relative to comb drive area on the MEMS mirror matrix.

FIG. 5a is a top view of the trace pace way configuration on the 18×9 mirror array with bond pads on the adjacent side of the device.

FIG. 5b is a top view of the trace pace way configuration on the 18×9 mirror array with bond pads on the bottom side of the device.

FIG. 5c is a top view of the trace pace way configuration on the 18×9 mirror array with bond pads on the top and bottom side of the device.

FIG. 5d is a top view of the MEMS mirror matrix device assembled.

FIG. 5e is a top view of a region A of FIG. 5d.

FIG. 5f is a top view of a region B of FIG. 5d.

FIG. 6 shows the process steps of the microfabrication of the MEMS mirror matrix.

FIG. 7 is a cross-section view of the metal routing layer sitting on substrate.

FIG. 8 is a cross-section view of the polysilicon-based routing layer sitting on substrate.

FIG. 9 is a cross-section view of the MEMS mirror matrix using BGA interconnection.

FIG. 9a is picture referenced from U.S. Pat. No. 10,551,613 showing the interconnection pad sitting on back of the chips.

FIG. 9b shows the interconnection pad sitting on the back and the perimeter of the chips.

FIG. 10a is the perspective view of the MEMS mirror matrix referenced to U.S. Pat. No. 10,551,613

FIG. 10b is the top of view MEMS mirror matrix and mirror shape.

FIG. 11 is the perspective view of the 2-dimensional MEMS mirror referenced to U.S. Pat. No. 10,551,613

FIG. 12 is the cross-section view of the MEMS mirror matrix that has the silicon tracing layer and the planar metal traces that run on the top surface of the device.

FIG. 13 is the cross-section view of the MEMS mirror matrix that consists of multiple high voltage routing layers.

FIG. 14A is a top view of multiple MEMS mirror matrix device assembled.

FIG. 14B is a top view of two MEMS mirror matrix device assembled.

FIG. 14C is a top view of four MEMS mirror matrix device assembled.

FIG. 15a shows the simulation result of trace resistance and mirror control voltage.

FIG. 15b shows the simulation result of parasitic capacitance and mirror control voltage.

FIG. 16a shows the mask layout of the interposer device.

FIG. 16b is the perspective view of interposer device.

FIG. 17a is the perspective view of MEMS mirror matrix.

FIG. 17b is the perspective detail view of interposer device with rear electrical contact.

FIG. 17c is the perspective view of the interposer device with rear electrical contact.

FIG. 18 is a perspective view of the MEMS mirror matrix having a glass cover.

### DETAILED DESCRIPTION OF THE INVENTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

In the following embodiments, ordinal numbers such as first, second, and so on are used to distinguish a plurality of components from one another. They are not intended to signify any particular order or to serve as permanent designations of the components. The components are not always required to be referred to by the same ordinal number. Depending on the embodiment or drawing, the same component may be referred to by different ordinal numbers.

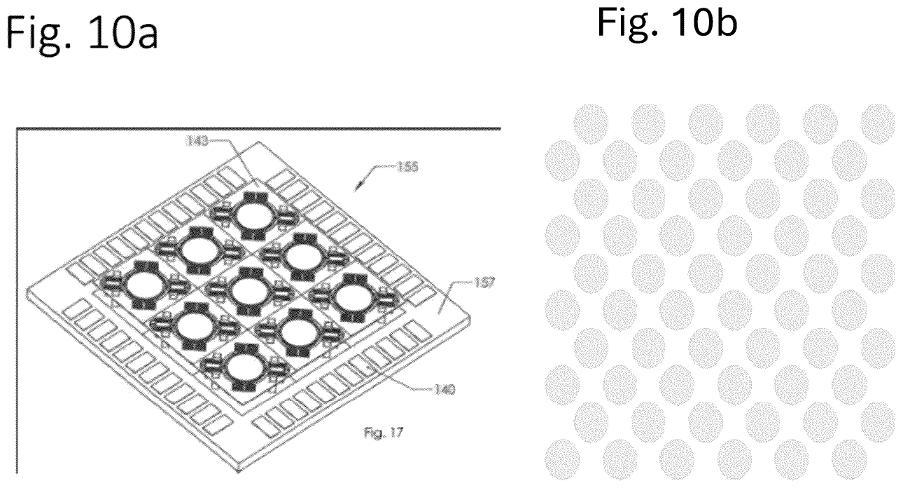

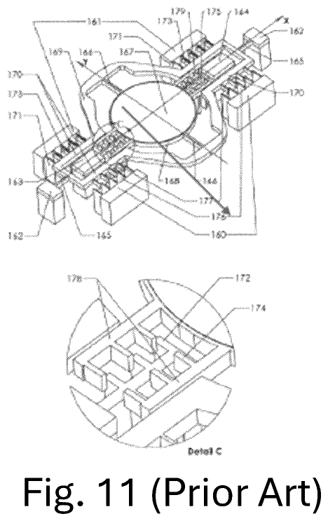

A mirror matrix device 1 as illustrated in FIG. 10 has mirrors spaced closely by the defined spacing extending in two directions forms of two-dimensional array. Referring to U.S. patent Ser. No. 10/551,613 (incorporated herein by reference) and shown in FIG. 11, each mirror has a reflector 167 that anchors to movable frame 169 via the two flexible beam 166 on each side of the reflector 167; the movable frame 169 is anchored to the substrate via another two flexible beam 165. The mirror has two rotation axis and tilts in four directions. First, mirror rotates about the flexible beam 166 as the electrostatic force generates from comb drive 178 when voltage is applied; on the other hand, mirror can also rotate in the oppose direction if the voltage is applied to 175; For the second rotating axis, the mirror rotates about the flexible beam 165 when a voltage is applied to comb drive 161 or comb drive 160. While the embodiment shown in the figures and described herein is a mirror device, it can be appreciated that other optical devices, such as but not limited to shutters, attenuators, etc. could be used instead of a mirror.

The mirrors are closely positioned to reduce the overall chip size and minimize the maximum tilting requirement of each mirror where each mirror needs to have enough tilting range to steer the light into the furthest port or mirror on the receiving end. Referring to FIG. 10b The mirror shape is often elliptical as the light enters the MEMS mirror at a shallow angle making the incident beam shape not circular.

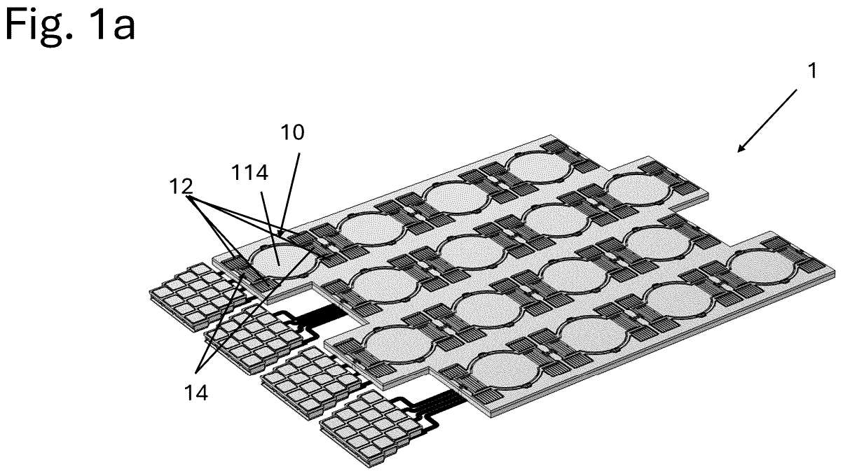

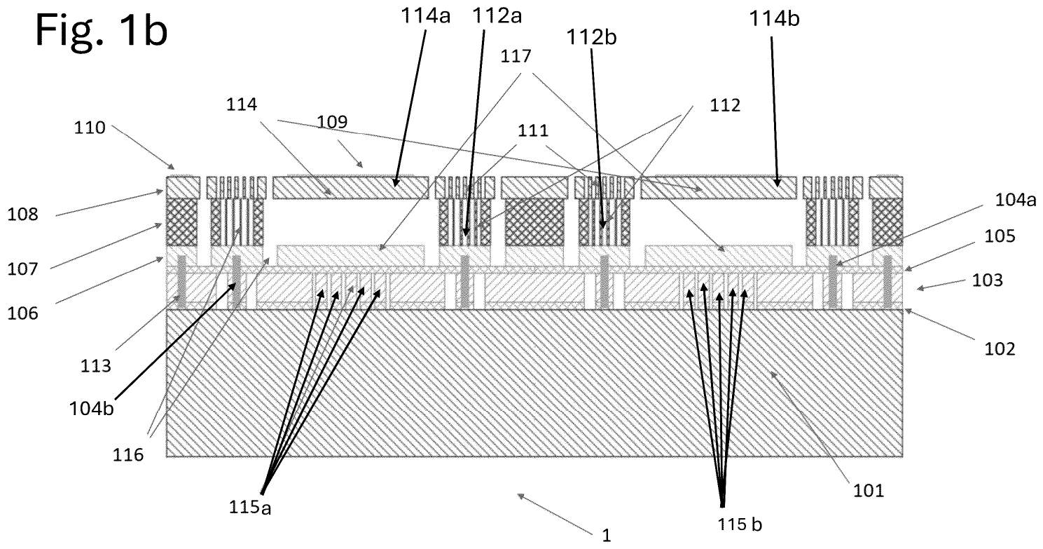

FIG. 1a shows one embodiment of the MEMS mirror matrix device 1 having a plurality of micromirror devices 10. In the preferred embodiment each micromirror device 10 includes two pairs of comb drives. The first pair of comb drives 12 are used to tilt the micromirror 114 about a first axis while the second pair of comb drives 14 is used to tilt the micromirror about a second axis. In one embodiment, the mirrors are arranged in linear rows and each linear row is offset from the adjacent rows. This allows for a compact arrangement of mirrors. However, it can also be appreciated other mirror configurations, including but not limited to alighted mirror in adjacent rows, is possible.

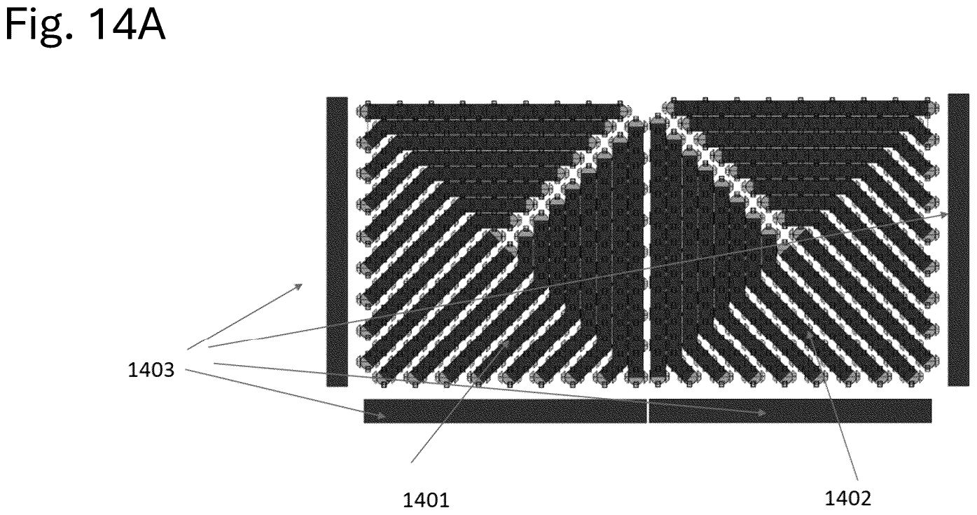

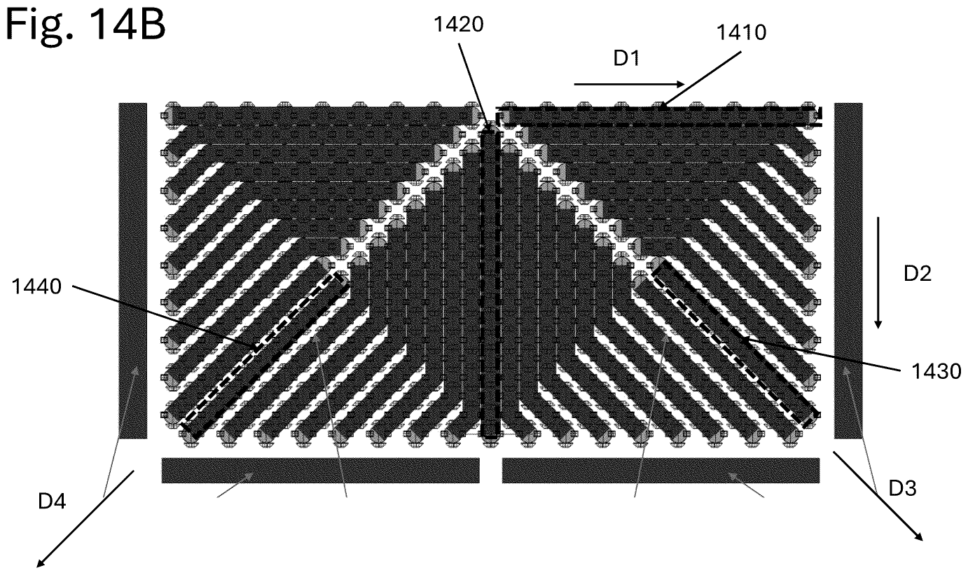

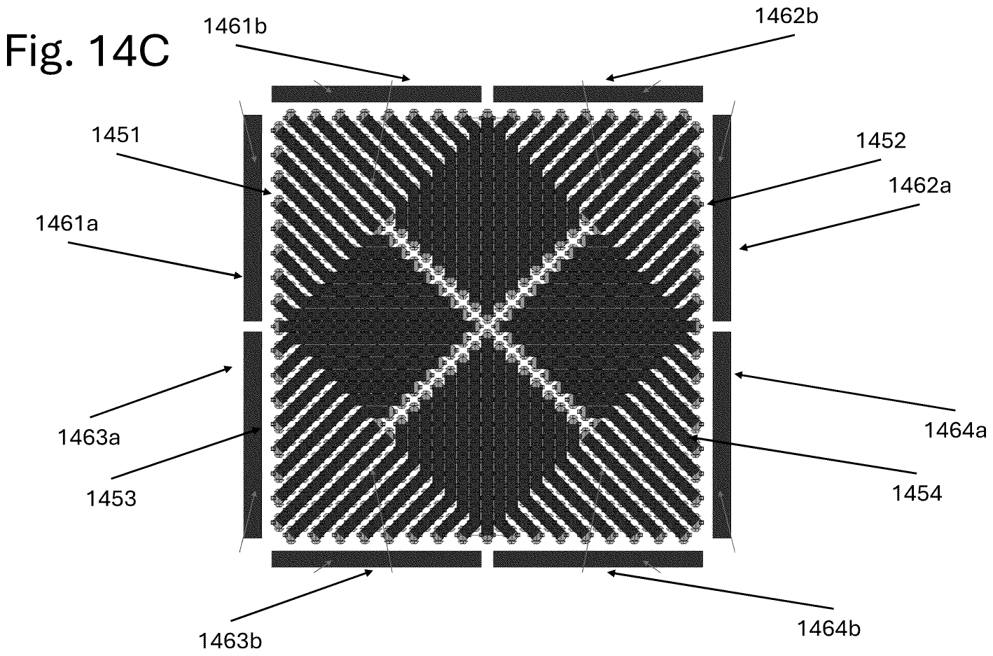

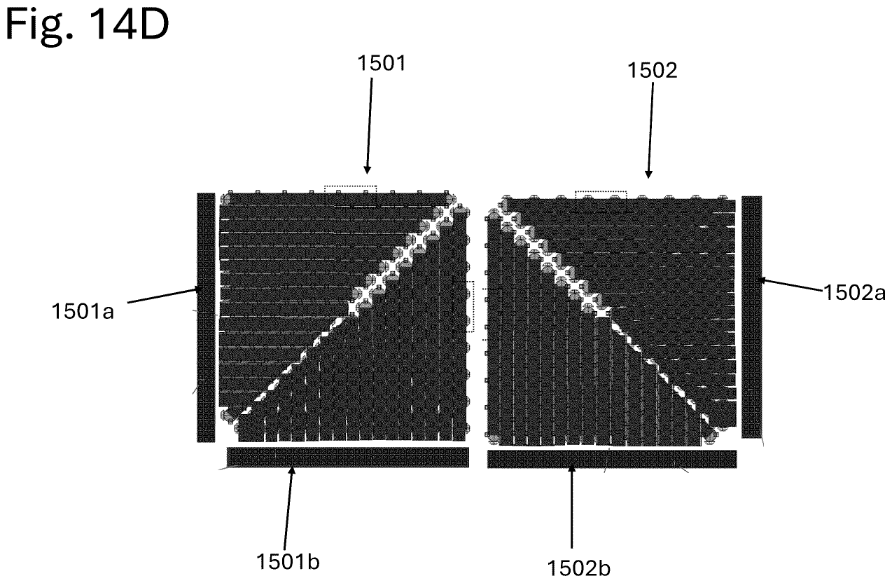

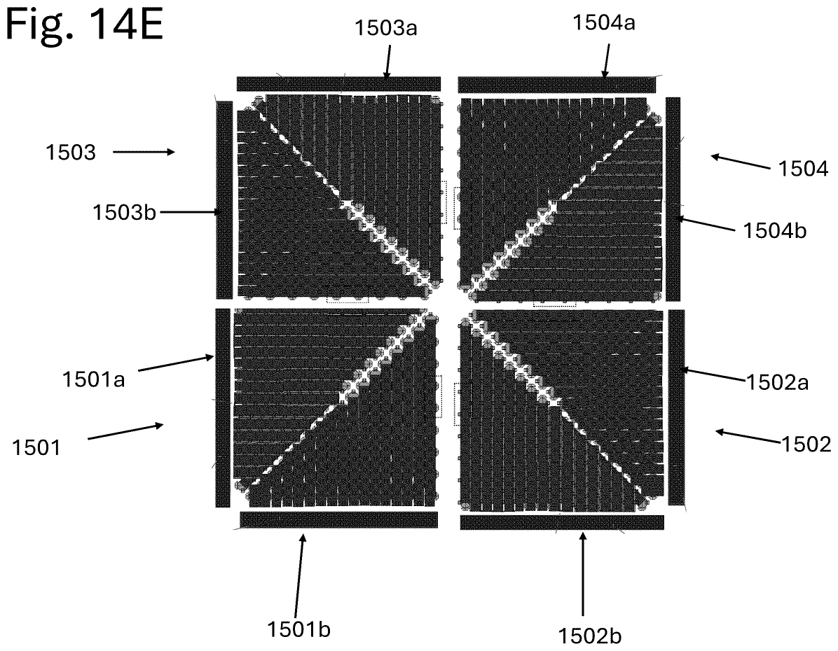

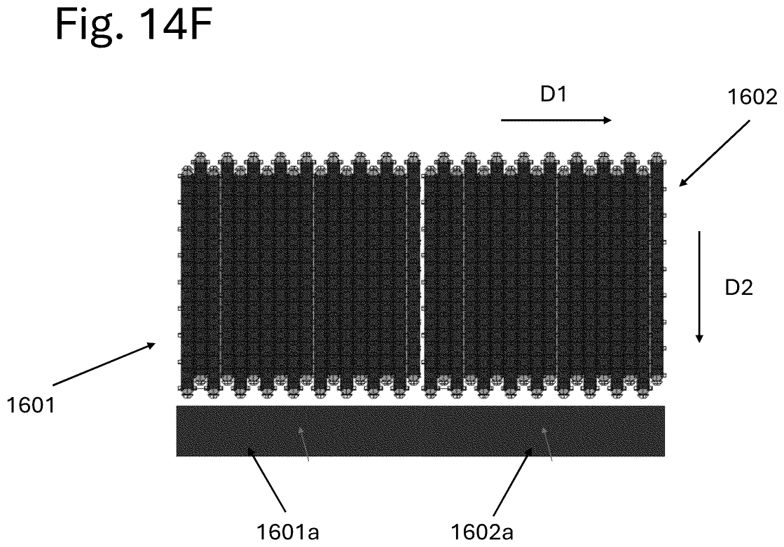

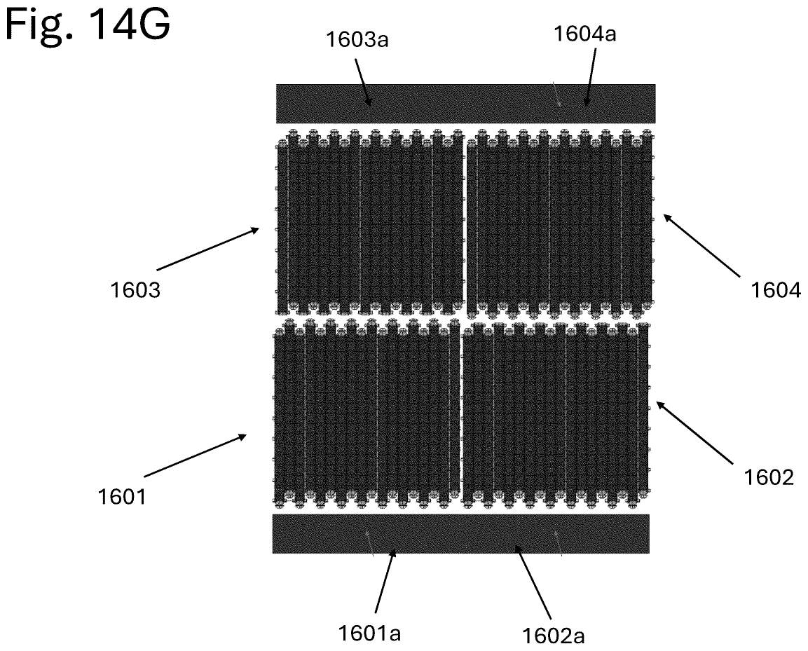

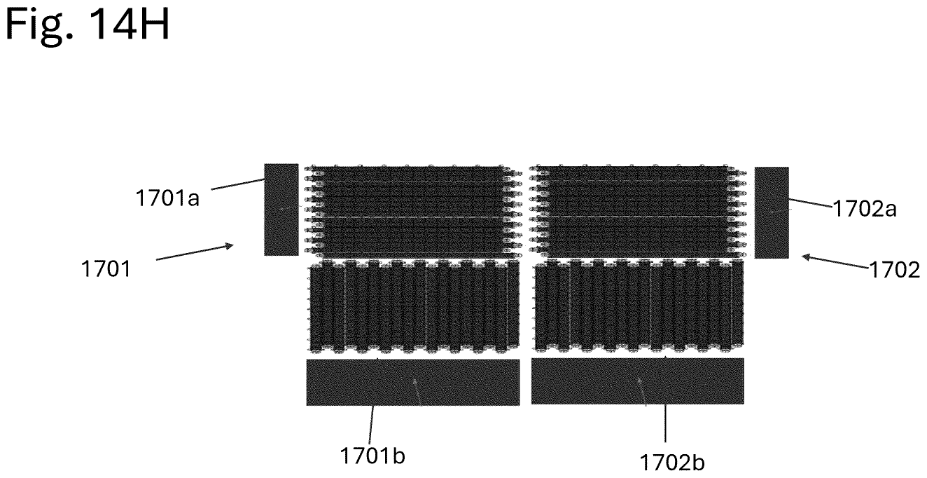

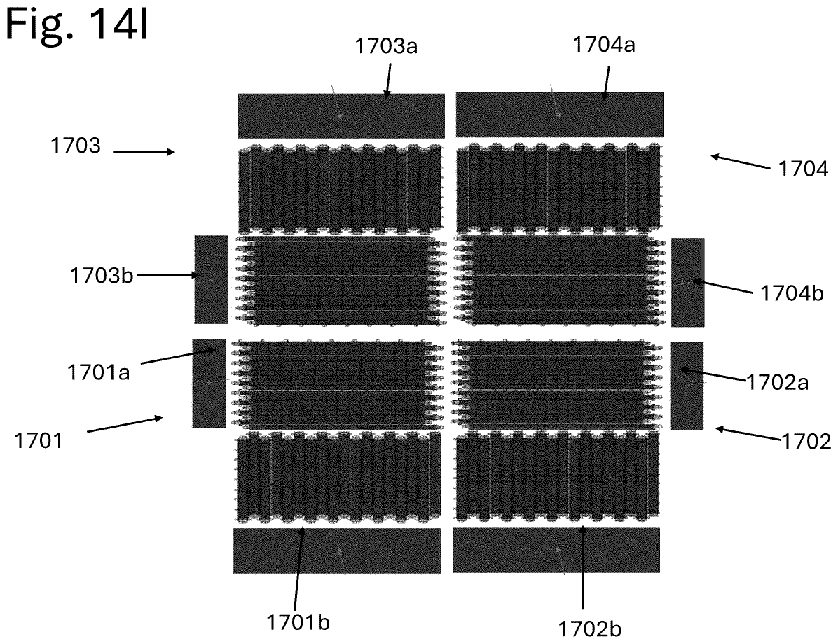

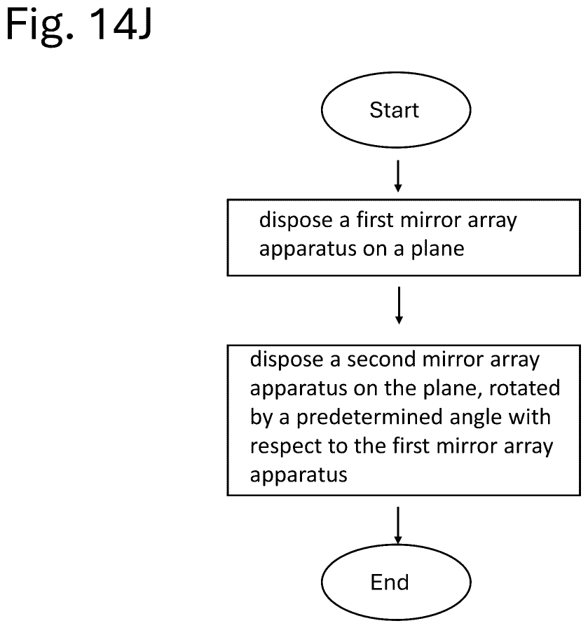

FIG. 1b shows a cross-section of the MEMS 2D mirror matrix device 1 that has multiple mirrors 114 sitting beside each other. The mirror matrix device 1 may consist of a substrate 101 and multiple conductive layers, including at least trace layer 103, electrode layer 106, and device layer 107 and 108. These conductive layers may be made from silicon, polysilicon, or other suitable semiconductor materials known to a person skilled in the art. Trace layer 103 is sandwiched between two thin dielectric insulating layers 102, 105 that may be made of silicon oxide or silicon nitride, or any other suitable material known to a person skilled in the art. The high voltage signal traces 115a and b are laid out across the device and are situated underneath the MEMS mirror 114 or alternatively within any part layer 106 that is not obstructed by the electrical via 113 the lower and stationary comb drive 112 and a shielding layer 117. The shield 117 is connected to ground through the device layer 108 and 107 and to package via wirebonding from wirebond pad 110, it forms an electrical shield underneath the mirror 114 and eliminate the interference and cross-talk of the electrical field generated by the high voltage signals that go through the signal traces 115a and b. The electrical connection from trace layer 103 to the electrode layer 106 and device layer 107 is achieved using polysilicon plug 113 and 104 via the, through silicon via (TSV), or any other method known to a person skilled in the art. The electrode layer 106 and device layer 107 may be made from the same device layer via multiple etching steps or made from multiple device layer via wafer bonding to achieve two or multiple steps height 116 underneath the mirror 114. The upper device layer 108 is also conductive and establishes vertical electrical connection to the layer below 107. Upper device layer 108 consists of the movable comb fingers 111, the mirror 114 and mirror reflector metal 109, as well as the wire-bonding pad 110 that may sit across the edge of the device to allow ease wire-bonding access. The wire bonding pad 110 may only sit on one of few sides of the chip to allow for chip-to-chip stitching to increase channel on the optical cross connect system as illustrated in FIG. 14. Layer 103 establishes a dense network of high voltage traces and fans out the signal to the edge of die where the poly plugs 113 allow a signal path to propagate vertically through electrode layer 106, device layer 107 and 108 to wire-bonding pad 110 and thereafter into the chip package.

As shown in FIG. 1b, the multiple mirrors 114 include a first mirror 114a and a second mirror 114b. The stationary comb drive 112 includes a first stationary comb drive 112a for driving the first mirror 114a and a second stationary comb drive 112b for driving the second mirror 114b. Further, the high voltage signal traces 115a and b includes a first high voltage signal trace 115a electrically coupled to the first stationary comb drive 112a and a second high voltage signal trace 115b electrically coupled to the second stationary comb drive 112b. The high voltage signal traces 115a and b are disposed below the multiple mirrors 114 and the stationary comb drive 112. The first stationary comb drive 112a is electrically connected to the first high voltage signal trace 115a through a first conductive via 104a. The second stationary comb drive 112b is electrically connected to the second high voltage signal trace 115b through a second conductive via 104b.

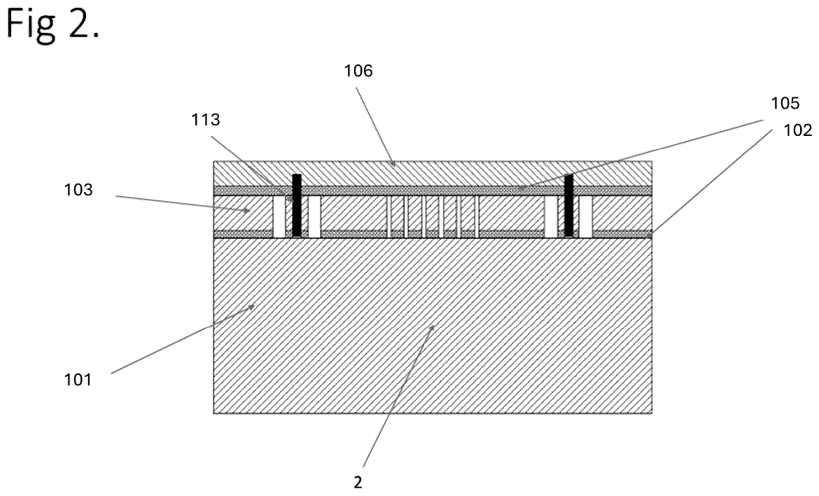

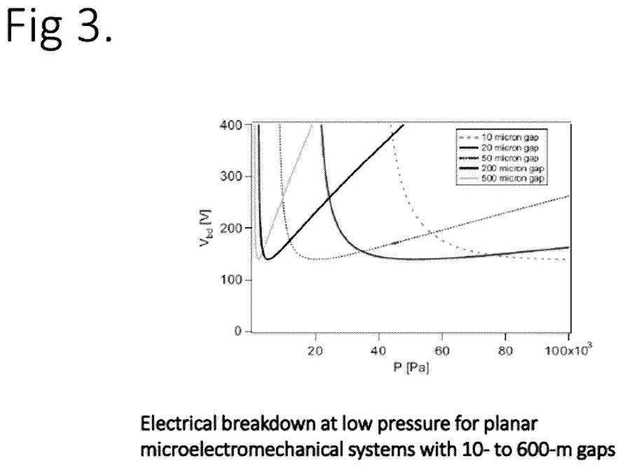

FIG. 2 shows a cross-section of the high voltage signal trace routing structure 2 that consists of a substrate 101, trace layer 103 for signal routing, two insulating layer 102 and 105 that is preferably made of silicon oxide, an electrode layer 106, and poly silicon plug 113 in designated area. The trace layer 103 is preferably made out of a single crystal silicon and is electrically isolated and sandwiched between two insulating layers 102 and 105. Vias 113 are preferably DRIE etched and filled with conductive polysilicon to allow electrical connection from the trace layer 103 to the electrode layer 106. The trace layer 102 is preferably made of highly doped single crystal silicon to reduce the resistance of the trace. The trace layer 103 is densely etched to form the required routing pattern to support the high channel count of the MEMS 2D mirror matrix, or other device type. The thickness of device layer 102 is preferably in the range of 5 to 10 um. The width and space of the trace preferably ranges from 10 to 20 um to ensure reduction of parasitic capacitance, cross-talk, and reduce electrical arcing. The low pressure and back filling of N2 during fusion bonding will ensure the breakdown voltage of the traces to reach over 250 v if pressure can be maintained at less than 20 Pa. as shown in FIG. 3. The trace layer 103, is preferably made of conductive material such as metal, silicon or other suitable materials known to a person skilled in the art. The trace layer 103 has varying doping concentration, thickness, resistivity, and thin film stress to accommodate the needs of high voltage requirement of the MEMS actuators.

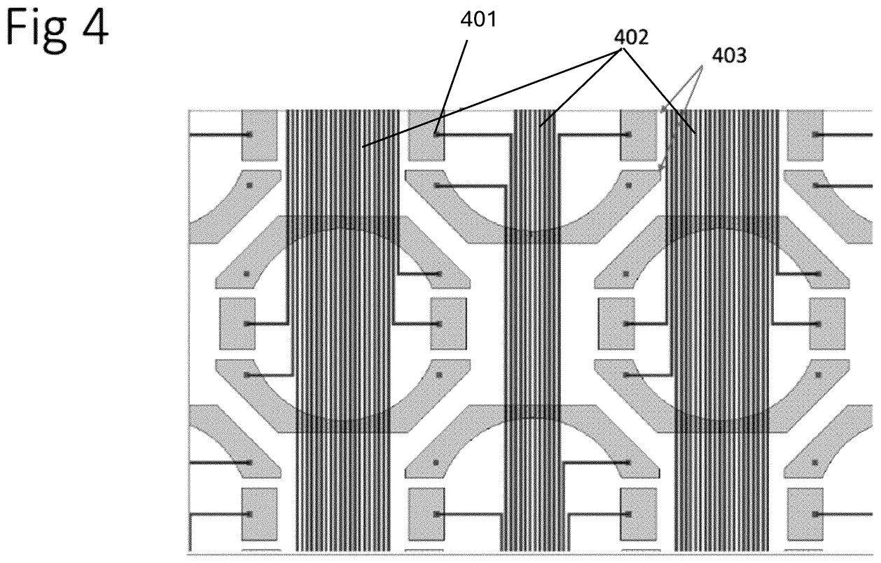

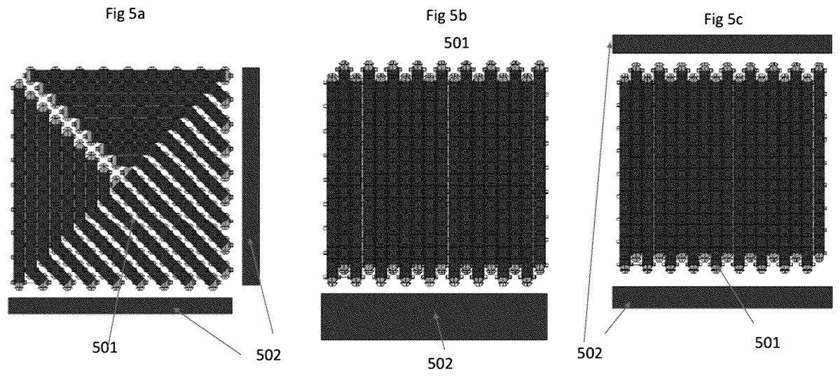

With reference to FIG. 4, each mirror on the mirror matrix requires four high voltage signal line connecting to each of the four electrodes in additional to the ground plane. The two-dimensional tilting mirror has one common grounding electrode and all the four high electrical potential electrodes are electrically isolated via the insulating layers and sit on the same substrate. As a result, the vertical connection from the trace layer 103 can be shorter in length and simplified and only extended to the next device layer 106 and completes the electrical connection to the comb drive. FIG. 4 shows the top view of the device revealing the location of vertical connection represented by dots, for example 401, relative to comb drive bases 403. The high voltage signal traces 403 are displayed to illustrate the density of the traces for large size of 2D MEMS mirror array.

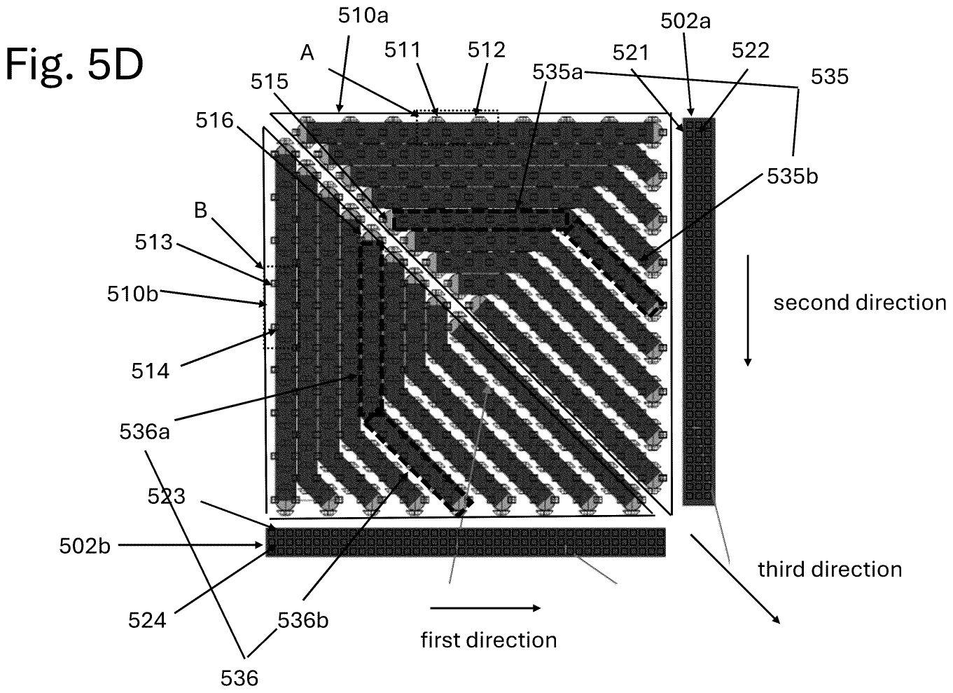

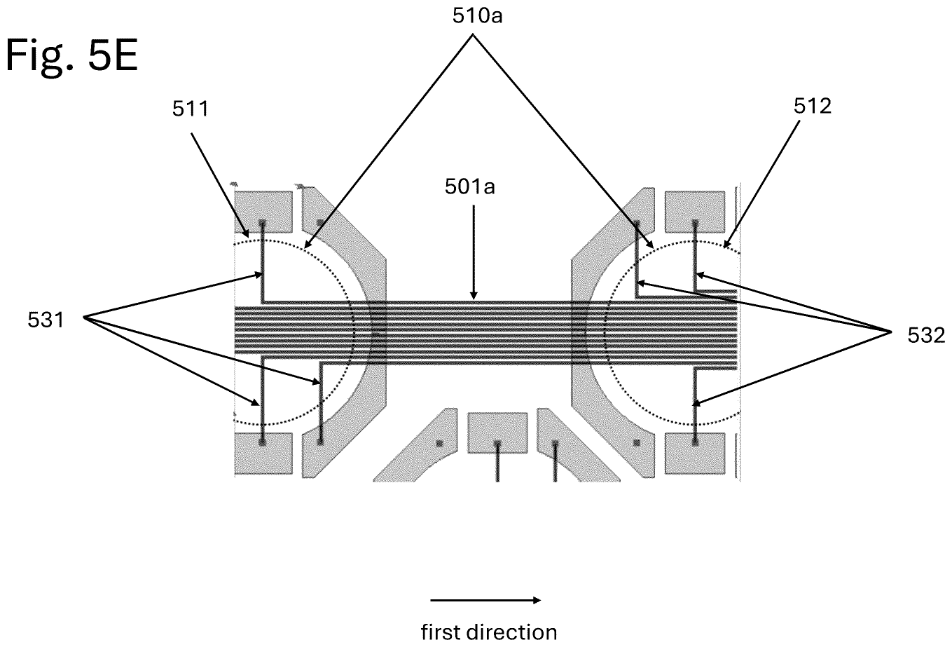

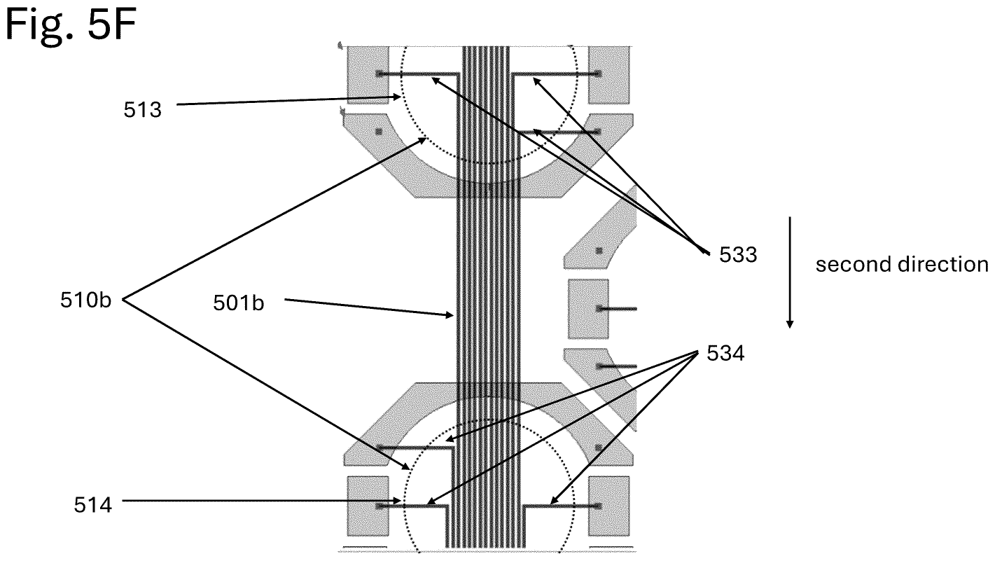

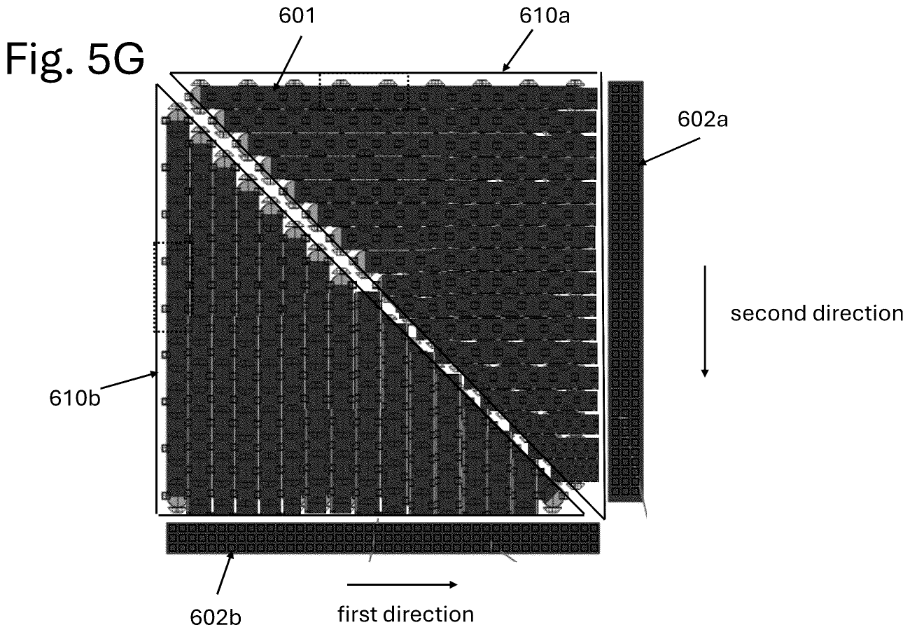

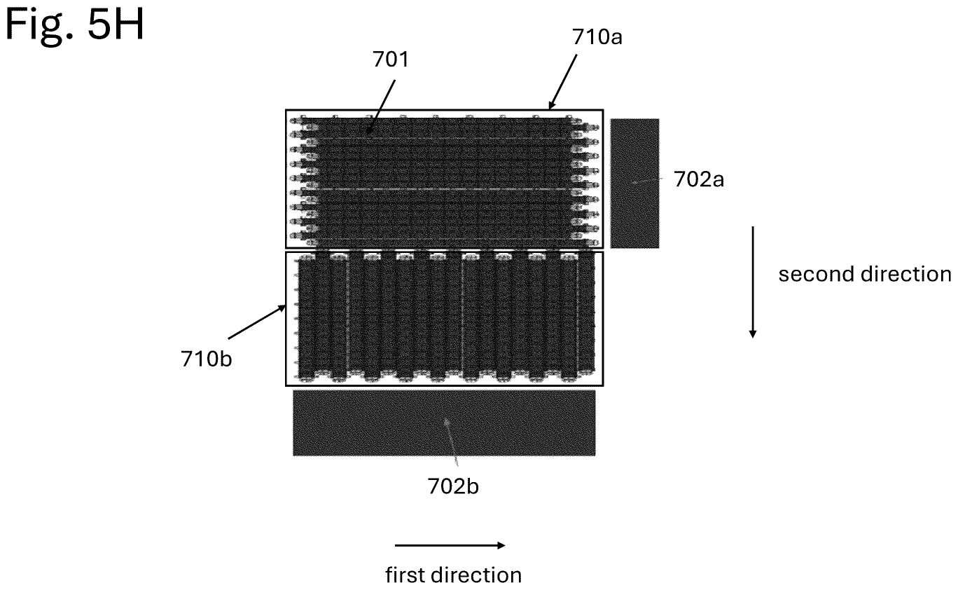

The device may utilize a fanout strategy to route the signal line to the parameter of the devices for ease of wire bonding access. Since the space left for signal routing is dramatically increased when compared to prior art which included traces between MEMS, the wire bonding pads may be placed on certain sides of the chip to enable to chip to chip stitching to further increase the array size without compromising the chip yield and cost. FIGS. 5a to 5h show the different configurations of mirror arrays. FIG. 5a shows a routing configuration of a 18×9 mirror matrix which consists of routing path 501 and two banks of wire bonding 502 on the adjacent sides of the mirror array device. FIG. 5b shows a routing configuration of a 18×9 mirror matrix which consists of routing path 501 which can be scaled in array size in the horizontal direction by put the bank of wire bonding 502 on only one side of the device. FIG. 5c shows a routing configuration of a 18×9 mirror matrix which consists of routing path 501 which can be scaled in array size in the horizontal direction by put the bank of wire bonding 502 on only two sides of the mirror array device.

FIG. 5d is a top view of the MEMS mirror array device assembled. FIG. 5e is a top view of a region A of FIG. 5d. FIG. 5f is a top view of a region B of FIG. 5d. As shown in FIGS. 5d, 5e and 5f, the 18×9 mirror matrix includes a first mirror 511, a second mirror 512, a third mirror 513 and a fourth mirror 514. The first mirror 511 and the second mirror 512 belong to a first mirror group 510a and are arranged along a first direction. The third mirror 513 and the fourth mirror 514 belong to a second mirror group 510b and are arranged along a second direction perpendicular to the first direction.

The mirrors arranged in a 2D matrix in the present application can be grouped in various ways. For example, the mirrors can be grouped into mirror groups based on which bonding array to which they are electrically associated. Furthermore, the mirrors can be grouped into mirror lines based on the paths of the traces associated with them.

In this regard, the mirror array device includes the first mirror group 510a and the second mirror group 510b. The mirrors of the first mirror group 510a are associated with the first bonding array 502a through the first traces and the mirrors of the second mirror group 510b are associated with the second bonding array 502b through the second traces.

The first mirror group 510a includes a plurality of first mirror lines and the second mirror group 510b includes a plurality of second mirror lines. At least a portion of the first mirror line is aligned parallel to the first direction and at least a portion of the second mirror line is aligned parallel to the second direction.

The plurality of first mirror lines are arranged along the second direction. Specifically, assuming the second direction is vertical, one of the two first mirror lines may be disposed above the other. The plurality of second mirror lines are arranged along the first direction. Specifically, assuming the first direction is horizontal, one of the two second mirror lines may be disposed next to the other.

Each of the first mirror lines includes a plurality of mirrors and each of the second mirror lines includes a plurality of mirrors. At least some of the mirrors included in the first mirror lines are arranged along the first direction and at least some of the mirrors included in the second mirror lines are arranged along the second direction.

The bank of wire bonding 502 includes a first bonding array 502a disposed on one side of the mirror matrix and extending in a second direction so that a longitudinal direction of the first bonding array 502a is parallel to the second direction, and a second bonding array 502b disposed on another side of the mirror matrix and extending in a first direction perpendicular to the second direction so that a longitudinal direction of the second bonding array 502b is parallel to the first direction.

Specifically, the first bonding array 502a may be disposed adjacent to one ends of the plurality of the first mirror lines and the second bonding array 502b may be disposed adjacent to one ends of the plurality of the second mirror lines. The one ends of the plurality of the first mirror lines may be arranged along the second direction. That is, a line consisting of the one ends of the plurality of the first mirror lines may be parallel to the second direction. The one ends of the plurality of the second mirror lines may be arranged along the first direction. That is, a line consisting of the one ends of the plurality of the second mirror lines may be parallel to the first direction.

On the other hand, the other ends of the plurality of the first mirror lines may not be arranged along the second direction. They may be arranged along a third direction which is described later. Likewise, the other ends of the plurality of the second mirror lines may be arranged along the third direction. Accordingly, a shape of the first mirror group 510a and a shape of the second mirror group 510b may be triangles and the longest side of the triangles may face each other.

When the first mirror group 510a and the second mirror group 510b form a shape having a plurality of sides, the first bonding array 502a and the second bonding array 502b are each disposed on two sides of the plurality of sides that are adjacent to each other. Thus, one end of the first bonding array 502a may be adjacent to one end of the second bonding array 502b.

Through this arrangement, the first bonding array 502a and the second bonding array 502b may form an L-shape. If the mirror matrix shown in FIG. 5d is rotated 90 degrees counterclockwise, the L-shape can be seen.

The first bonding array 502a includes a first bonding pad 521 electrically coupled to a first trace 531 and a second bonding pad 522 electrically coupled to a second trace 532. The second bonding array 502b includes a third bonding pad 523 electrically coupled to a third trace 533 and a fourth bonding pad 524 electrically coupled to a fourth trace 534.

The routing path 501 includes a first trace group 501a associated with the first mirror group 510a and a second trace group 501b associated with the second mirror group 510b. As shown in FIG. 5e, the first trace group 501a includes the first trace 531 associated with the first mirror 511 and extending to the first bonding pad 521 in the first direction, and the second trace 532 associated with the second mirror 512 and extending to the second bonding pad 522 in the first direction. The first trace 531 associated with the first mirror 511 passes below the second mirror 512, and at least a portion of the first trace 531 overlaps the second mirror 512.

As shown in FIG. 5f, the second trace group 501b includes the third trace 533 associated with the third mirror 513 and extending to the third bonding pad 523 in the second direction, and the fourth trace 534 associated with the fourth mirror 514 and extending to the fourth bonding pad 524 in the second direction. The third trace 533 associated with the third mirror 513 passes below the fourth mirror 514, and at least a portion of the third trace 533 overlaps the fourth mirror 514.

In this way, the traces may overlap other mirrors and pass below the other mirrors to allow the trace to extend from a mirror to the bonding pads via a shortest path.

At least one of the plurality of the first mirror lines is angled at a first angle and at least one of the plurality of the second mirror lines is angled at a second angle. Specifically, as shown in FIG. 5d, the 18×9 mirror matrix further includes a fifth mirror 515 and a sixth mirror 516. The routing path 501 further includes a fifth trace 535 associated with the fifth mirror 515, and a sixth trace 536 associated with the sixth mirror 516. The fifth traces 535 include a first portion 535a extending from the fifth mirror 515 in the first direction and a second portion 535b extending from an end of the first portion 535a in a third direction different from the first direction and the second direction. For example, the third direction may be diagonal in case that the first direction is horizontal and the second direction is vertical. In this case, the first angle is 45 degrees. The second portion 535b extends to the first bonding array 502a.

The sixth traces 536 include a first portion 536a extending from the sixth mirror 516 in the first direction and a second portion 536b extending from an end of the first portion 536a in the third direction different from the first direction and the second direction. For example, the third direction may be diagonal in case that the first direction is horizontal and the second direction is vertical. In this case, the second angle is 45 degrees. The second portion 536b extends to the second bonding array 502b.

In this way, the traces may include the first vertical or horizontal portion and the second diagonal portion, to allow the trace to extend from a mirror to the bonding pads via a shortest path.

Other variations and layouts of the mirror array to achieve the same or similar advantages described above would be obvious to a person skilled in the art in light of this disclosure.

FIG. 5G shows a variation of the example shown in FIG. 5D. Referring to FIG. 5D, the mirror array device includes a routing path 601, a first mirror group 610a and a second mirror group 610b. The first mirror group 610a includes a plurality of first mirror lines having first mirrors and the second mirror group 610b includes a plurality of second mirror lines having second mirrors. The description of the same elements and the same arrangements as the example of FIG. 5D can be applied to this example, thus duplicate description is omitted hereinafter.

The routing path 601 includes first traces associated with the first mirrors and second traces associated with the second mirrors. The first traces are electrically connected to the first bonding array 602a and the second traces are electrically connected to the second bonding array 602b.

In this example, the first mirror lines and the second mirror lines are not angled. The first mirror lines are aligned parallel to the first direction without being curved or angled and the second mirror lines are aligned parallel to the second direction without being curved or angled. Accordingly, the traces do not need to be curved or angled, and the complexity of the manufacturing process can be reduced.

The first bonding array 602a is disposed adjacent to one end of the first mirror lines and the second bonding array 602b is disposed adjacent to one ends of the first mirror lines. The other ends of the first mirror lines face the other ends of the second mirror lines. Thus, the first bonding array 602a and the second bonding array 602b are disposed on edges or sides of the mirror array device.

The first bonding array 602a is aligned with the second direction and the second bonding array 602b is aligned with the first direction. Thus, the first bonding array 602a is perpendicular to the second bonding array 602b. One end of the first bonding array 602a is adjacent to one end of the second bonding array 602b. They may form an L-shape.

FIG. 5H shows another routing configuration of a mirror array device which consists of a routing path 701 and bonding arrays 702a and 702b disposed on the adjacent sides or edges of the mirror array device. The mirror matrix includes the first mirror group 710a and the second mirror group 710b. The first mirror group 710a includes a plurality of first mirror lines and the second mirror group 510b includes a plurality of second mirror lines. Each of the first mirror line is aligned parallel to the first direction and each of the second mirror line is aligned parallel to the second direction.

Each of the first mirror lines includes a plurality of first mirrors and each of the second mirror lines includes a plurality of second mirrors. Each of the first mirrors may be arranged along the first direction and each of the second mirrors may be arranged along the second direction.

The routing path 701 includes the first traces associated with the first mirrors and the second traces associated with the second mirror lines. The first traces may be aligned with the first mirror line. The second traces may be aligned with the second mirror line.

The first bonding array 702a may be disposed on one side of the mirror matrix and extending in a second direction so that a longitudinal direction of the first bonding array 702a is parallel to the second direction. The second bonding array 702b may be disposed on another side of the mirror matrix and extending in the first direction perpendicular to the second direction so that a longitudinal direction of the second bonding array 702b is parallel to the first direction.

Specifically, the first bonding array 702a may be disposed adjacent to one ends of the plurality of the first mirror lines and the second bonding array 702b may be disposed adjacent to one ends of the plurality of the second mirror lines. The first mirror group 710a and the second mirror group 710b are disposed next to each other along the second direction. When the first mirror group 710a and the second mirror group 710b form a shape having a plurality of sides such as a rectangle, the first bonding array 702a and the second bonding array 702b are each disposed on two sides of the plurality of sides that are adjacent to each other.

FIGS. 14A and 14B show the embodiment of stitching two MEMS mirror matrix chips together. In this embodiment, the MEMS mirror matrix chip shown in FIG. 5D may be used. Multiple MEMS mirror matrix chips 1401 and 1402 can be assembled together without affecting the mirror pitch dimension and increase the channel count inside an optical cross connecting system. Utilizing the above mentioned fanout structure using routing layer 103, thousands of high voltage signals line and bonding pad array 1403 which are located on the edge of the chip enable chips and chips stitching. This configuration reduces the chip cost as the die yield varies exponentially as the quantity as well as failure rate of mirrors on each chip. In this way, a delay of signals to multiple mirrors can be minimized.

FIG. 14B shows the embodiment of stitching two MEMS mirror matrices together. Multiple MEMS mirror matrices includes a plurality of first mirrors 1410 disposed in a first direction D1, a plurality of second mirrors 1420 disposed in a second direction D2 perpendicular to the first direction D1, a plurality of third mirrors 1430 disposed in a third direction D3 different from the first direction D1 and the second direction D2, and a plurality of fourth mirrors 1440 disposed in a fourth direction D4 different from the first direction D1, the second direction D2 and the third direction D3. The multiple MEMS mirror matrices further includes a first trace associated with one mirror of the plurality of first mirrors 1410, a second trace associated with one mirror of the plurality of second mirrors 1420, a third trace associated with one mirror of the plurality of third mirrors 1430, and a fourth trace associated with one mirror of the plurality of fourth mirrors 1440. The first trace extends below other mirrors of the plurality of first mirrors 1410 in the first direction D1 and is electrically connected to a first drive configured to drive the one mirror of the plurality of first mirrors 1410. At least portion of the first trace overlaps the other mirrors of the plurality of first mirrors 1410. The second trace extends below other mirrors of the plurality of second mirrors 1420 in the second direction D2 and is electrically connected to a second drive configured to drive the one mirror of the plurality of second mirrors 1420. At least portion of the second trace overlaps the other mirrors of the plurality of second mirrors 1420. The third trace extends below other mirrors of the plurality of third mirrors 1430 in the third direction D3 and is electrically connected to a third drive configured to drive the one mirror of the plurality of third mirrors 1430. At least portion of the third trace overlaps the other mirrors of the plurality of third mirrors 1430. Further, the fourth trace extends below other mirrors of the plurality of fourth mirrors 1440 in the third direction D4 and is electrically connected to a fourth drive configured to drive the one mirror of the plurality of fourth mirrors 1440. At least portion of the fourth trace overlaps with the other mirrors of the plurality of fourth mirrors 1440.

FIG. 14C shows the embodiment of stitching four MEMS mirror matrix chips together. Multiple MEMS mirror matrix chips 1451, 1452, 1453 and 1454 can be assembled together without affecting the mirror pitch dimension and increase the channel count inside an optical cross connecting system. The four MEMS mirror matrix chips 1451, 1452, 1453 and 1454 which are assembled together may compose a mirror matrix module. They may be arranged in a 2×2 matrix. Utilizing the above mentioned fanout structure using routing layer 103, thousands of high voltage signals line and bond pads 1461a, 1461b, 1462a, 1462b, 1463a, 1463b, 1464a, and 1464b which are located on the edge of the chip and enable chips and chips stitching. This configuration reduces the chip cost as the die yield varies exponentially as the mirror quantity as well as failure rate of mirrors on each chip. Alternative embodiments that may have the same or similar advantages are described below.

FIGS. 14 D and 14E show another embodiment of stitching a plurality of MEMS matrix chips together. In this embodiment, the mirror array device shown in FIG. 5G may be used. Referring to FIG. 14D, two MEMS mirror matrix chips 1501 and 1502 can be assembled together without affecting the mirror pitch dimension and increase the channel count inside an optical cross connecting system.

Referring to FIG. 14E, four MEMS mirror matrix chips 1501, 1502, 1503 and 1504 can be assembled together without affecting the mirror pitch dimension and increase the channel count inside an optical cross connecting system. The four MEMS mirror matrix chips 1501, 1502, 1503 and 1504 which are assembled together may compose a mirror matrix module. They may be arranged in a 2×2 matrix. All the bonding arrays 1501a, 1501b, 1502a, 1502b, 1503a, 1503b, 1504a, 1504b may be disposed on the edges or sides of the mirror matrix module.

FIGS. 14 F and 14G show another embodiment of stitching a plurality of MEMS matrix chips together. In this embodiment, the mirror matrix device shown in FIG. 5B may be used. Referring to FIG. 14F, two MEMS mirror matrix chips 1601 and 1602 can be assembled together without affecting the mirror pitch dimension and increase the channel count inside an optical cross connecting system.

Each of the multiple MEMS mirror matrix chips 1601 and 1602 includes a plurality of mirror lines which are arranged side by side along the first direction D1. Each of the plurality of mirror lines includes a plurality of mirrors which are arranged side by side along the second direction D2. Each of the bond pads 1601a, 1602a is disposed on one ends of the mirror lines so that the bonds bads 1601a, 1602a are parallel to the first direction. When the two MEMS mirror matrix chips 1601 and 1602 are stitched together, the two bonding arrays 1601a, 1602a may be aligned on the same line.

Referring to FIG. 14G, four MEMS mirror matrix chips 1601, 1602, 1603 and 1604 can be assembled together without affecting the mirror pitch dimension and increase the channel count inside an optical cross connecting system. The four MEMS mirror matrix chips 1601, 1602, 1603 and 1604 which are assembled together may comprise a mirror matrix module. They may be arranged in a 2×2 matrix. All the bonding arrays 1601a, 1602a, 1603a, 1604a may be aligned with the first direction D1. Two of them may be aligned on the same line and the other two of them may be aligned on the other same line. Furthermore, they may be disposed along the edges or the sides of the mirror matrix module.

FIGS. 14 H and 14I show another embodiment of stitching a plurality of MEMS matrix chips together. In this embodiment, the mirror array device shown in FIG. 5H may be used. Referring to FIG. 14H, two MEMS mirror matrix chips 1701 and 1702 can be assembled together without affecting the mirror pitch dimension and increase the channel count inside an optical cross connecting system.

Referring to FIG. 14I, four MEMS mirror matrix chips 1701, 1702, 1703 and 1704 can be assembled together without affecting the mirror pitch dimension and increase the channel count inside an optical cross connecting system. The four MEMS mirror matrix chips 1701, 1702, 1703 and 1704 which are assembled together may compose a mirror matrix module. They may be arranged in a 2×2 matrix. All the bonding arrays 1701a, 1701b, 1702a, 1702b, 1703a, 1703b, 1704a, 1704b may be disposed along the edges or the sides of the mirror matrix module.

According to the embodiments of FIGS. 14A-14I, the mirror array module can be manufactured by adjusting the rotation angle or placement angle of a plurality of MEMS mirror matrix chips of one type. Thus, manufacturing efficiency can be improved.

FIG. 14J shows a flow chart of a method for manufacturing the mirror array module. Through the method for manufacturing mirror array module, at least one of the mirror array modules described in FIGS. 14A-14I can be manufactured. Accordingly, the description regarding the mirror array modules described in FIGS. 14A-14I can be applied to an embodiment of the method without any mention.

Referring to FIG. 14J, the method may comprises disposing a first mirror array apparatus including first mirrors and first bonding arrays on a plane (S2000), and disposing a second mirror array apparatus including second mirrors and second bonding arrays on the plane, rotated by a predetermined angle with respect to the first mirror array apparatus (S2100). Accordingly, the first bonding arrays and the second bonding arrays may be located along edges of the mirror array module.

Specifically, a plurality of mirror array apparatus used for manufacturing the mirror array module may be of the same type. Thus, the first mirror array apparatus and the second mirror array apparatus may be of the same type. In the step of S2100, the second mirror array apparatus may be rotated by 90 degrees counterclockwise or clockwise with respect to the first mirror array apparatus.

Furthermore, a third mirror array apparatus and a fourth mirror array apparatus may be disposed on the plane in order to manufacture the mirror array modules shown in FIGS. 14C, 14E, 14G and 14I.

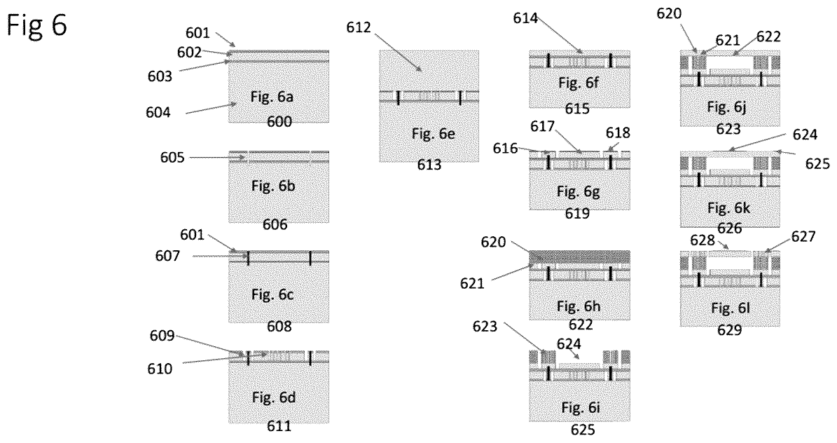

FIG. 6 reveals the microfabrication process flow that is used to manufacture the high-density mirror matrix device 2. As shown in FIG. 6a, an SOI wafer 600 consists of a 5 um highly doped device silicon 602, a 2 um buried oxide 603, and a 700 um handle silicon 604. The SOI wafer 600 is processed and left with thermal oxide masking layer 601 which is patterned and DRIE etched to form the vertical trench 605 that is 2 to 5 um in width and length and 15 um deep.

Referring to FIG. 6b, part 606 is ready for the CVD polysilicon refill. As shown in FIG. 6c, part 606 is deposited with poly silicon within site dopant to fill up the vertical trench 605. Part 608 is then mechanically grinded and polished and thin down to the thermal oxide masking layer 601.

FIG. 6d shows that part 608 is lithographically patterned and DRIE etched to form the electrically isolated island 609. The silicon traces 610 that is free-standing and insulated from the bottom silicon oxide is formed within device layer 202 and become part 611. Throughout cleaning and visual inspection or even probing must be done at this stage to ensure the traces are functional without shorting.

Part 613 as referring to FIG. 6e, a double-side polished wafer 612 is fusion bonded with filling of N2 at low pressure at less than 20 Pa to part 611 from the top side. High temperature annealing at 900c is proceed on part 611 to ensure good bonding strength and achieve high hermeticity within the routing layer 202.

Referring to FIG. 6f, part 613 is flipped upside down and gets thinned down to around 50 to 75 um and form layer 614 for the bases of lower comb drive. The top surface (handle side) 614 is polished and ready for the next masking layer to be deposited on part 615. Alternatively, top surface 614 can be thicker to allow for the electrode layer and stationary comb fingers to be made from the same layer. In this embodiment, surface 614 would first be etched down to the insulator to form the deep trenches around the comb finger island. Next it would be etched a second time to define the stationary comb fingers.

Referring to FIG. 6g. part 615 is patterned and etched to form the electrical isolated island 616 for the comb drive and electrical shield 617 underneath the mirror and transform to part 622. As referred to FIG. 6h, the masking layer 618 is removed and part 622 will be prepped for fusion bonding. Another SOI wafer will be bonded and with its handle removed to form the new device layer 620. Referring to FIG. 6i, device layer 620 is lithographically patterned and DRIE etched to form the lower comb drive 623 on top of 616, the mirror cavity 624 is formed concurrently and electrical shield that sits below the mirror 617 that is electrically grounded to the top of device layer and part 625 is ready for next processing step.

As referring to FIG. 6j, a processed wafer 620 has area 612 recessed to avoid the lower comb drive 623 bonding to the area 621. Area 622 on the processed wafer 620 may be DRIE etch to reduce the weight of the mirror and improve the weight and drive force ratio for each mirror. The processed wafer 620 is bonded to part 625 and form part 623. As shown in FIG. 6k, part 624 is metalized on the surface of wafer 620 to form reflector 624. Part 626 is metalized again to form thicker metal film that is useful for wire-bonding. Part 626 is then lithographically patterned and etched to form the upper comb finger 627 and release the mirror structure 628. As referring to FIG. 6l, after the cleaning, the mirror array device 629 completes the microfabrication and is ready dicing and die sorting.

Instead of using hermetically sealed silicon traces to connect the electrodes, there may be different variation that is similar to the disclosed invention to allow for high density and stitch-able MEMS mirror matrix.

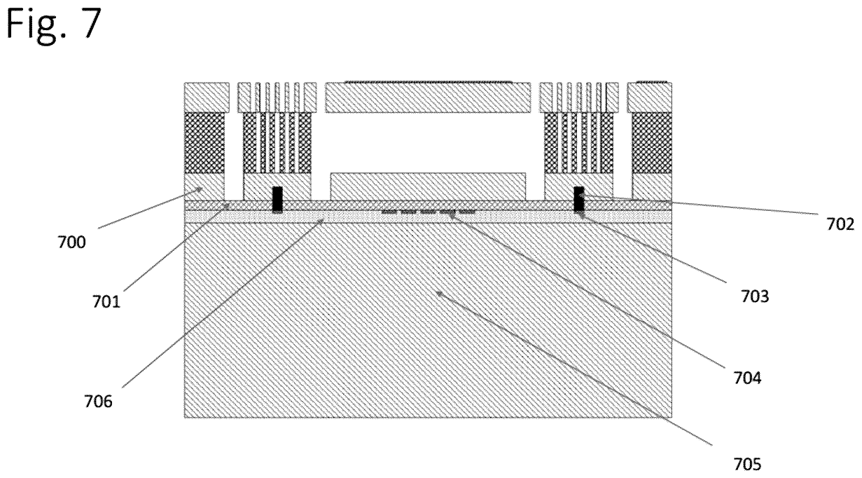

Another construction of the MEMS mirror matrix high voltage signal routing structure can be seen in FIG. 7. The thin film metal, such as aluminum, copper, gold and be used to construct the traces 704 and metal contact 703 in the high voltage signal routing layer. The doped poly silicon filled vias 702 are produced in the double side polished silicon wafer 700. After growing a layer of thermal oxide 701 on the front side of silicon wafer 700, the metal traces 704 and metal contact 703 are patterned and deposited and establish electrical connection to the via 702. The insulating dielectric thin film such as CVD silicon oxide or silicon nitride 703 may be deposited and followed by planarization before bonding to another silicon wafer 705.

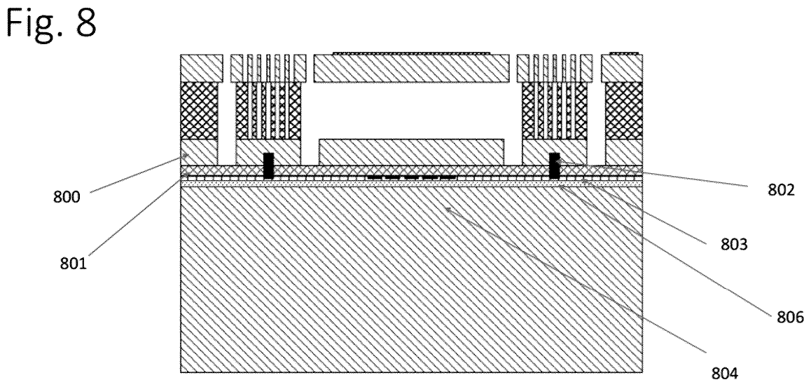

Another construction of the MEMS mirror matrix and its routing structure can be seen in FIG. 8. The routing trace is made of polysilicon. After growing a layer of thermal oxide 801 on the front side of silicon wafer 800, the doped poly silicon is deposited to fill the via 802 and etched to define the signal traces 804. A layer of silicon nitride 803 is deposited to passivate the trace and planarized before a thin layer of PECVD silicon oxide 804 is deposited. A silicon wafer 805 is bonded to become the handle layer of the wafer.

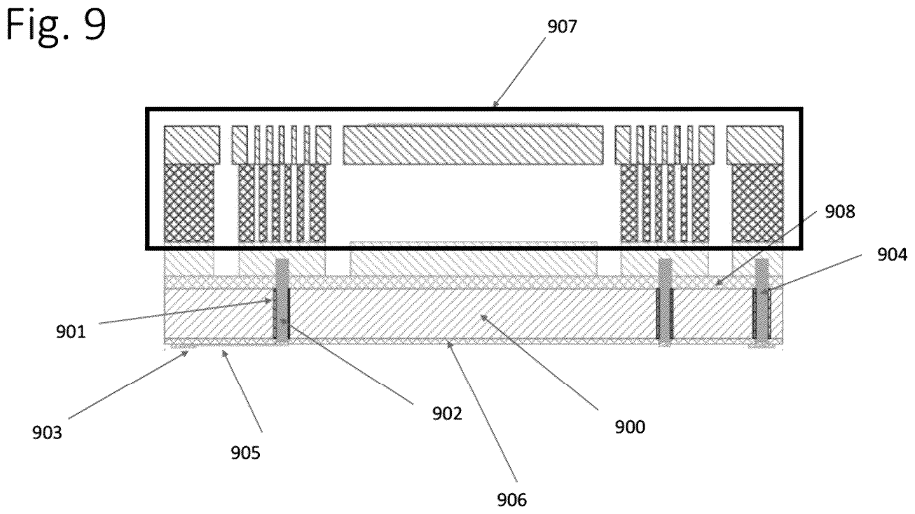

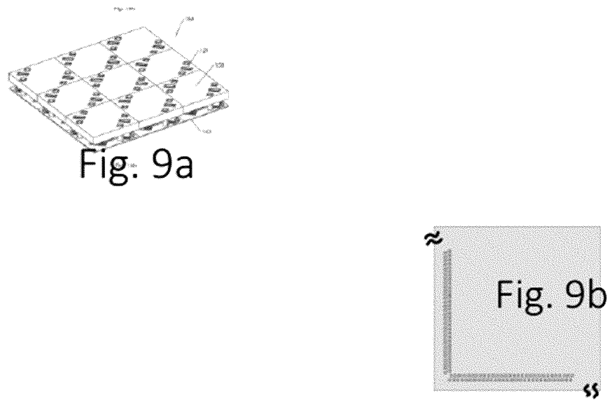

As referred in FIG. 9. another construction of MEMS mirror matrix 900 can be found in FIG. 9. The device 900 consists of the before mentioned mirror and comb structure 907 which sits on a thin dielectric film insulating section 907 and substrate 900. The poly plugs 902 and 904 are used to establish electrical connection between substrate 900 and the metal layer which consists of wire-bonding pad 903 and wire-bonding trace 905. The metal layer 905 sits on the back of substrate 900 and is electrically isolated via another dielectric layer 906 that may be made of silicon oxide, silicon nitride, or glass. The polysilicon plugs 902 may be exposed from back of the device and metalized and form interconnect pads 903 and allow chip to chip carrier connection directly using solder ball. Referring to FIG. 9a, the electrical connection, wire bonding pad 903 at the back of the chip can be placed directly underneath the device and distributed evenly across the chip. The solder ball which will be placed directly between 903 and connection on the chip carrier may exert stresses to the device after curing and thermal processes. To mitigate this issue, the insulating layer 906 and metal layer 905 can be utilized to fan out the traces to the edge of the device. As referred to FIG. 9b, a chip with fanout wire-bonding situated on the back and perimeter of the device can be found.

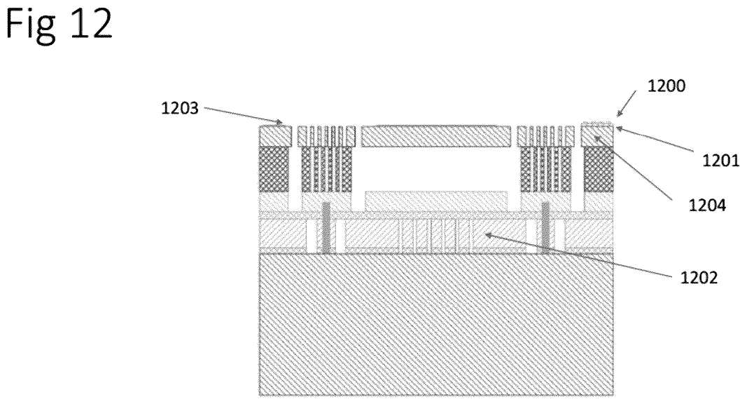

As referred to FIG. 12, a variation of the MEMS mirror matrix and it is high voltage signal routing structure may consist of a third device layer 1202 and additional routing layer unitizing the additional space on the front side of the device. The front side of the device consists of an insulating layer 1201 that may be made of silicon oxide or silicon nitride to electrically isolated metal trace 1200 from the device silicon 1204.

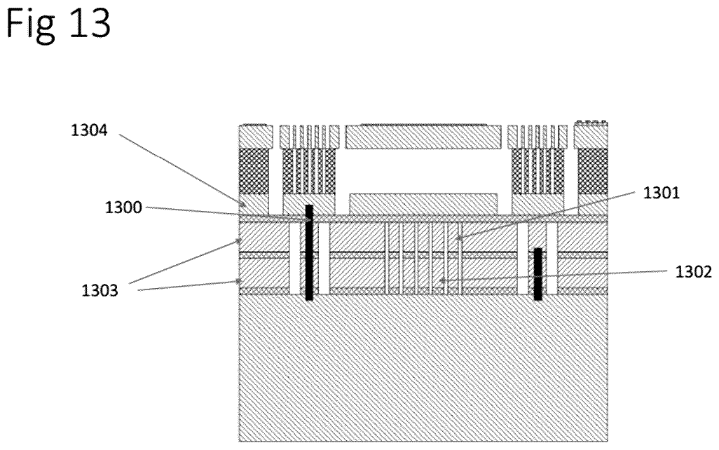

As referred to FIG. 13. A MEMS mirror matrix may consist of a stack and multiple routing layers to further increase routing space to allow for larger mirror matrix to be built. The poly silicon filled via 1300 is used to establish electrical connection to each routing layers 1303 and comb drive layer 1304. The silicon tracing structures 1301 and 1302 are insulated by the thin dielectric material 1303 that can be made of silicon oxide or silicon nitride.

The electrical property of the connection trace layout would affect the performance of the MEMS mirror array. The factors including the trace resistance and trace parasitic capacitance etc. In FIG. 15a, an embodiment of the relationship between the trace resistance and control voltage coupling ratio is shown. Larger trace resistance could lead to lower electrical coupling ratio between the trace and MEMS structures. Meanwhile, in FIG. 15b, the plot shows an embodiment of the mirror response time and the parasitic capacitance. The mirror response rate will be longer when there is a larger parasitic capacitance between the traces. The trace resistance and the parasitic capacitance could be determined by the trace configuration and the material used. All the dimensions and the material used for the trace connection need to be optimized to achieve a lower coupling ratio and shorter response time.

While the preferred embodiment has been described as having a plurality of comb drives that move a micromirror about two axis, it can be appreciated that the device can be used in other applications. For example, the above principles can also apply to a mirror matrix module comprising a plurality of mirrors that have micro-machining enabled actuators such as electrostatic comb drive, or piezo-electric drive that move the mirror up and down. The comb drive will have stationary fingers anchored on the electrode layer 106, and movable finger coupled to the mirror and supported by flexure anchored to device layer 108. As in FIG. 1a, comb drives 12 can be energized and generate a downward force to bring the mirror down into the substrate and generate piston moving motion. In this embodiment, the drive signal is routed via the trace layer that is situated below the mirrors to the perimeter of the chip for easier wirebonding access.

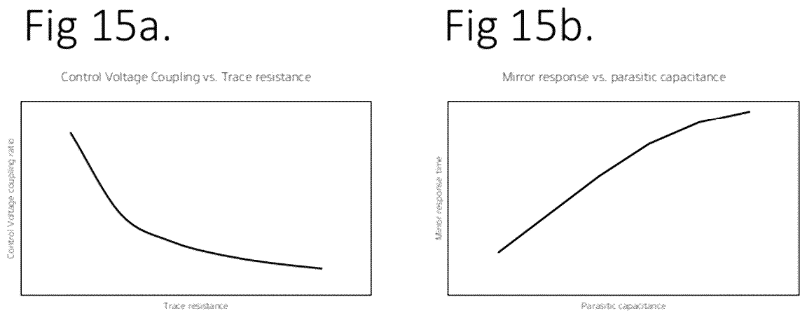

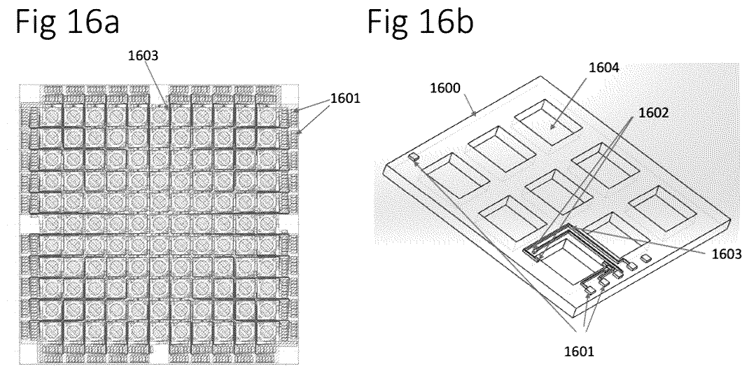

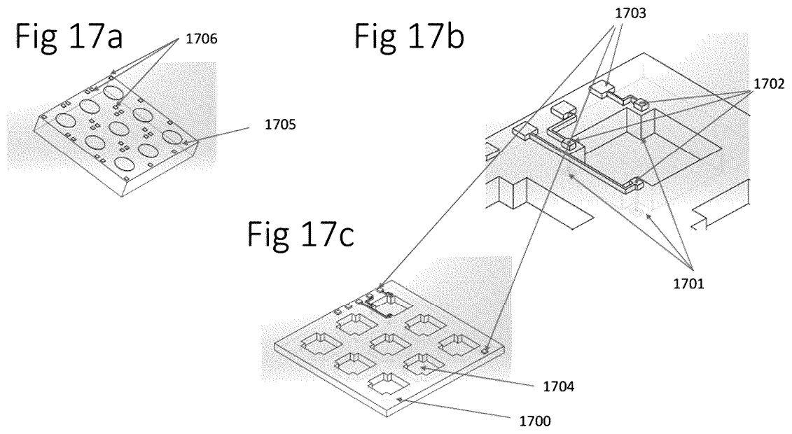

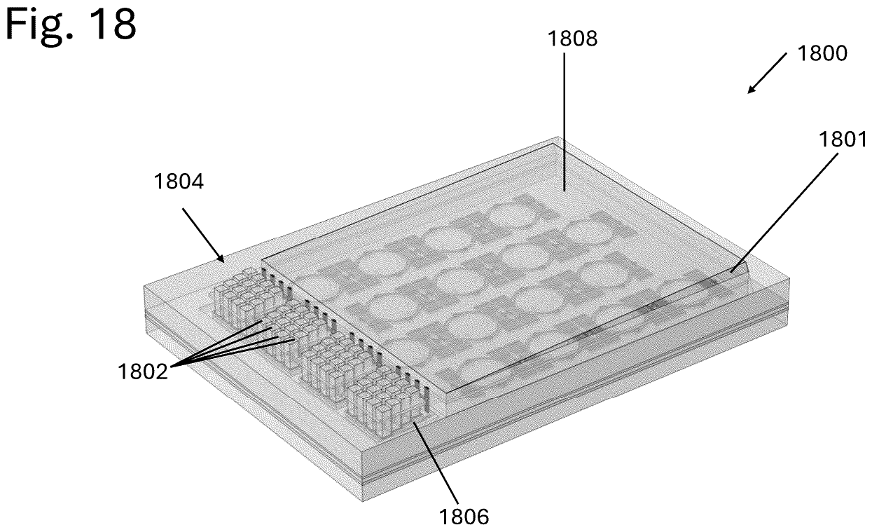

In another embodiment shown in FIG. 18, the construction of the mirror matrix 1800 comprises a glass cover 1801 that has a sloped window with antireflection coating to eliminate back reflection to the optical inputs and outputs. The glass cover is micromachined in wafer form and is to be attached to the MEMS matrix wafer 1808 directly via anodic bonding, or micro welding technique. The glass cover 1801 comprises trench refilled via that has electrical contacts 1802 at the back of the glass cover 1801 which make contact to the mirror matrix bond pads 1804 directly. The exposed electrical contacts on the front side of the glass wafer become the wirebond pad 1804 that connects to the package and electronics. The glass cover 1801 may have recessed cavity 1806 near the electrical connection to accommodate the thicker metal layer that will be pressed in to form strong contact while the non-recessed area will make contact directly to MEMS matrix wafer and provide hermeticity seal to the MEMS device. The glass cover 1801 may have another recessed cavity situated above the mirror array to accommodate the movement of the mirror during operation. Another embodiment includes a silicon routing structure, referred to the interposer device 1600 may be fabricated separately and assembled to the MEMS mirror matrix wafer. As shown in FIG. 16b, an interposer device 1600 which may be made of silicon, glass, quartz, consists of optical openings 1604, local wire-bonding pads 1602, routing traces 1603, and external wire-bonding pad 1601. The opening 1604 is designed to enable optical and wire bonding access to the wire-bonding pads on the MEMS mirror matrix. The connection from the MEMS mirror device will be established via wire-bonding wire connecting the bond pads of MEMS mirror device to the local wire-bonding pads 1601 on the interposer device 1600. The routing trace 1603 enables electrical connections from each MEMS mirror 143 as illustrated in FIG. 10a. to the perimeter of the interposer device 1600 therefore fanout the signal. The interposer 1600 is attached to the MEMS mirror device 143 via an adhesive or solder, or even wafer bonding. After two devices are assembled and secured to a chip carrier or package, the wire-bonding may be used to complete the electrical connection. As referring in FIGS. 17a,b and c, the interposer 1601 may have electrical contact 1701 at the back of the interposer device 1700 to allow for direct electrical connection between the metal contact 1706 of MEMS mirror matrix 1705, 143 and rear metal contact of interposer device 1700 via soldering, conductive epoxy or any kind of wafer bonding technique such as, fusion bonding, eutectic bonding, or anodic bonding. The interposer device 1700 consists of electrical contacts 1701 on the backside of the device, electrical vias 1702, and front side wire-bonding pads 1703, and the opening 1704 to allow for optical access to the MEMS mirror. The electrical vias 1702 may utilize the through silicon via or similar processes to connect the rear electrical contacts 1701 vertically to the front side electrical contacts 1703. The frontside electrical contacts may be placed strategically on different parts of the chip to allow for chip cascading or chip stitching to form a larger array of device as referred to FIG. 14. The interposer device 1700 may utilize a before mentioned construction 2 that can establish interconnection via method of chip-to-chip assembly to the MEMS mirror matrix 1705, 143 via front, back, side of chip. The interposer device 1700 may utilize a before mentioned construction 2 and may consist multiple layers of traces.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A mirror array apparatus comprising:
a substrate layer;
a first trace layer;
an electrode layer; and
a device layer;
the mirror array apparatus comprising a plurality of micro mirrors, each micro mirror comprising:
a device; and
at least one pair of comb drives;
wherein the device is configured to be in the device layer, said device coupled to at least one pair of movable combs in the at least one pair of comb drives;
said moveable combs configured to cooperate with at least one pair of stationary combs to facilitate movement of the device about a first axis;
the first trace layer being electrically coupled to the at least one pair of stationary combs through an electrode layer;
said first trace layer selectively insulated from said substrate layer and said electrode layer to electrically couple a first stationary comb and second stationary comb in said at least one pair of stationary combs to a first trace in said first trace layer and a second trace in said trace layer respectively; and
wherein the device is disposed above the first trace layer, and a grounded shield is located between the trace layer and the device.

2. The mirror array of claim 1 wherein the at least one pair of comb drives comprises two pairs of comb drives, a first comb drive and a second comb drive, and the second pair of comb drives comprises a third stationary comb and a forth stationary comb, electrically coupled to a third trace and forth trace in said first trace layer respectively; wherein said second pair of comb drives is configured to move the device about a second axis.

3. The mirror array of claim 2 wherein the first, second, third and forth traces in said first trace layer are electrically isolated from each other by a dielectric material.

4. The mirror array of claim 3 wherein the dielectric material is chosen from the list consisting of air, nitrogen, inert gas, silicon oxide, and nitrite.

5. The mirror array of claim 3 wherein the first trace layer is made of silicon.

6. The mirror array of claim 3 wherein the first trace layer is configured such that the signal is received at a first edge of said mirror array.

7. The mirror array of claim 6 wherein the first trace layer is configured such that the signal is received at the first edge and a second edge of said mirror array.

8. The mirror array of claim 6 wherein the first trace layer is configured such that the signal is received at the first edge, the second edge and a third edge of said mirror array.

9. The mirror array of claim 6 wherein the first trace layer is configured such that the signal is received at the first edge, the second edge, the third edge and a fourth edge of said mirror array.

10. The mirror array of claim 1 further comprising:
a second trace layer positioned below the first trace layer with an intermediary insulation layer therebetween;
the second trace layer having a plurality of traces electrically coupled to the electrode layer;
said second trace layer selectively insulated from said substrate layer and said electrode layer to electrically couple one or more stationary comb drives of one or more of the plurality of micromirrors in the mirror array to one or more corresponding traces in the second trace layer.

11. A mirror array apparatus comprising a plurality of mirror arrays as claimed in claim 6 comprising at least a first mirror array and a second mirror array arranged adjacent each other such that the first edge of the first mirror array and first edge of the second mirror array are aligned such that an electrical signal to the mirror array apparatus is received on one side of the mirror array apparatus.

12. A mirror array apparatus comprising a plurality of mirror arrays as claimed in claim 7 comprising at least a first mirror array and a second mirror array arranged adjacent each other such that the first edge of the first mirror array and first edge of the second mirror array are aligned along a primary edge of the mirror array apparatus and the second edge of the first mirror array and the second edge of the second mirror array are positioned parallel to each other on opposite sides of the mirror array apparatus such that an electrical signal to the mirror array apparatus is received on two sides of the mirror array apparatus.

13. The mirror array apparatus of claim 12 comprising a third mirror array and a fourth mirror array arranged adjacent each other such that the first edge of the third mirror array and first edge of the fourth mirror array are aligned along a primary edge of the mirror array apparatus and the second edge of the third mirror array and the second edge of the fourth mirror array are positioned parallel to each other on opposite sides of the mirror array apparatus such that an electrical signal to the third and fourth mirror array is received on two sides there of; said third and fourth mirror array positioned adjacent said first and second mirror array such that the first and second mirror array is a mirror image of the third and fourth mirror array and electrical signal is received on 4 sides of the mirror array apparatus.

14. A mirror array apparatus comprising:
a mirror array including a first mirror and a second mirror;
a drive array including a first drive configured to drive the first mirror and a second drive configured to drive the second mirror; and
a trace layer including a first trace electrically coupled to the first drive and a second trace electrically coupled to the second drive,
wherein the mirror array is disposed above the trace layer, and
at least portion of the first trace overlaps the second mirror and passes below the second mirror.

15. The mirror array apparatus of claim 12, wherein:
the mirror array includes a first mirror group including the first mirror and the second mirror, and a second mirror group including a third mirror and a fourth mirror,
the trace layer further includes a third trace associated with the third mirror and a fourth trace associated with the fourth mirror, and
at least portion of the third trace overlaps the fourth mirror and passes below the fourth mirror.

16. The mirror array apparatus of claim 13, further comprising:
a first bonding array including a first bonding pad electrically coupled to the first trace and a second bonding pad electrically coupled to the second trace; and
a second bonding array including a third bonding pad electrically coupled to the third trace and a fourth bonding pad electrically coupled to the fourth trace.

17. The mirror array apparatus of claim 14, wherein the first bonding array extends in a first direction perpendicular to a second direction in which the second bonding array extends.

18. The mirror array apparatus of claim 15, wherein the first trace includes a first portion extending to the first bonding array in the second direction perpendicular to the first direction in which the first bonding array extends and a second portion extending to the first bonding array in a third direction different from the first direction and the second direction.

19. The mirror array apparatus of claim 16, wherein the third trace includes a third portion extending to the second bonding array in the first direction perpendicular to the second direction in which the second bonding array extends and a second portion extending to the first bonding array in the third direction different from the first direction and the second direction.

20. The mirror array apparatus of claim 14, wherein the first bonding array and the second bonding array extend in a first direction.

21. The mirror array apparatus of claim 18, wherein:
the first trace extends to the first bonding array in a second direction perpendicular to the first direction, and
the third trace extends to the second bonding array in the second direction.

22. The mirror array apparatus of claim 12, further comprising:
a first via electrically connecting the first drive to the first trace; and
a second via electrically connecting the second drive to the second trace.

23. The mirror array apparatus of claim 12, wherein the trace layer includes a first trace layer including the first trace and a second trace layer including the second trace, and
the first trace layer is disposed above the second trace layer.

24. A mirror array apparatus comprising:
a plurality of first mirrors disposed in a first direction;
a plurality of second mirrors disposed in a second direction perpendicular to the first direction; and
a plurality of third mirrors disposed in a third direction different from the first direction and the second direction,
wherein a first trace associated with one mirror of the plurality of first mirrors extends below other mirrors of the plurality of first mirrors in the first direction,
wherein a second trace associated with one mirror of the plurality of second mirrors extends below other mirrors of the plurality of second mirrors in the second direction, and
wherein a third trace associated with one mirror of the plurality of third mirrors extends below other mirrors of the plurality of third mirrors in the third direction.

25. The mirror array apparatus of claim 22, wherein:
at least portion of the first trace overlaps the other mirrors of the plurality of first mirrors,
at least portion of the second trace overlaps the other mirrors of the plurality of second mirrors, and
at least portion of the third trace overlaps the other mirrors of the plurality of third mirrors.

26. The mirror array apparatus of claim 22, wherein:
the first trace is electrically connected to a first drive configured to drive the one mirror of the plurality of first mirrors,
the second trace is electrically connected to a second drive configured to drive the one mirror of the plurality of second mirrors, and
the third trace is electrically connected to a third drive configured to drive the one mirror of the plurality of third mirrors.

27. The mirror array apparatus of claim 22, further comprising:
a plurality of fourth mirrors disposed in a fourth direction different from the first direction, the second direction and the third direction,
wherein a fourth trace associated with one mirror of the plurality of fourth mirrors extends below other mirrors of the plurality of fourth mirrors in the third direction.

28. The mirror array apparatus of claim 22, wherein:
the fourth trace is electrically connected to a fourth drive configured to drive the one mirror of the plurality of fourth mirrors, and
at least portion of the fourth trace overlaps the other mirrors of the plurality of fourth mirrors.

29. A mirror array apparatus comprising:
a plurality of first mirrors;
a plurality of first drives configured to drive the plurality of first mirrors, respectively;
a plurality of first traces electrically connected to the plurality of first drives, respectively;
a plurality of second mirrors;
a plurality of second drives configured to drive the plurality of second mirrors, respectively; and
a plurality of second traces electrically connected to the plurality of second drives, respectively;
wherein one first trace of the plurality of first traces passes below the plurality of first mirrors and at lease portion of the one first trace overlaps with the plurality of first mirrors, and
wherein one second trace of the plurality of second traces passes below the plurality of second mirrors and at lease portion of the one second trace overlaps with the plurality of second mirrors.

30. The mirror array apparatus of claim 27, further comprising:
a first bonding array including a plurality of first bonding pad electrically connected to the plurality of first traces, respectively; and
a second bonding array including a plurality of second bonding pad electrically connected to the plurality of second traces, respectively.

31. The mirror array apparatus of claim 28, wherein:
the plurality of first mirrors are arranged in a row in a first direction,
the first bonding array extends in a second direction perpendicular to the first direction, the plurality of second mirrors are arranged in a row in the second direction, and
the second bonding array extends in the first direction perpendicular to the second direction.

32. The mirror array apparatus of claim 28, wherein:
the first bonding array is disposed on one side of the plurality of first mirrors and the plurality of second mirrors,
the second bonding array is disposed on other side of the plurality of first mirrors and the plurality of second mirrors,
the plurality of first mirrors and the plurality of second mirrors are arranged in a row in a first direction, and
the first bonding array and the second bonding array extend in a second direction perpendicular to the first direction.
